(19) United States
(12) Patent Application Publication
(10) Pub. No.: US 2008/0304664 A1
(43) Pub. Date: Dec. 11, 2008

(54) SYSTEM AND A METHOD FOR SECURING INFORMATION

(76) Inventor: Shanmugathasan Suthaharan, Greensboro, NC (US)

Correspondence Address: SMITH MOORE LEATHERWOOD LLP, P.O. BOX 21927, GREENSBORO, NC, 27420, US

(21) Appl. No.: 11/759,457

(22) Filed: Jun. 7, 2007

(51) Int. Cl. H04L 9/28

(52) U.S. Cl. 380/46

(57) ABSTRACT

A system for securing information is disclosed. The system includes a key, a sub-key generator, and an encryptor/decryptor. The sub-key generator includes a first security module. The encryptor/decryptor includes a second security module. At least a portion of the key is an input to the sub-key generator, and a sub-key is an output. At least a portion of the sub-key is an input to the encryptor/decryptor, and a cipher text or a plain text, depending on the operational, is an output. In an aspect, the first security module and the second security module are substantially the same.

The present invention relates generally to an information securing system, a method for securing information, and an algorithm for securing information. More particularly, the present invention relates to a security module useable in an information securing system, a method for using a security module as a key generator and an encryptor/decryptor for securing information, and an algorithm for a security module useable in an information securing system.

There remains a need for a new and improved information securing system, a method for securing information, an algorithm for securing information and, more particularly, a security module useable in an information securing system, a method for using a security module as a key generator and an encryptor/decryptor for securing information, and an algorithm for a security module useable in an information securing system.

### SUMMARY

The present invention is directed to a system for securing information that includes a key, a sub-key generator, and an encryptor/decryptor. The sub-key generator includes a first security module. The encryptor/decryptor includes a second security module. At least a portion of the key is an input to the sub-key generator, and a sub-key is an output. At least a portion of the sub-key is an input to the encryptor/decryptor, and a cipher text or a plain text, depending on the operation, is an output. In one aspect, the first security module and the second security module are substantially the same.

Accordingly, one aspect of the present invention is to provide a security module useable in a system for securing information comprising a sub-key generator, an encryptor/decryptor, or a sub-key generator and an encryptor/decryptor. The security module includes in linkable arrangement an expander, a combiner, a scrambler, and a multiple flag hasher.

Another aspect of the present invention is to provide a system for securing information that includes a key, a sub-key generator, and an encryptor/decryptor. The sub-key generator includes a first security module including a multiple flag hasher. The encryptor/decryptor includes a second security module including a multiple flag hasher. At least a portion of the key is an input to the sub-key generator, and a sub-key is an output. At least a portion of the sub-key is an input to the encryptor/decryptor, and a cipher text or a plain text, depending on the operational, is an output.

Still another aspect of the present invention is to provide a method for securing information including providing one or more keys, generating one or more sub-keys using at least one of the one or more keys, and converting a plain text to a cipher text using one or more sub-keys in combination with one or more of an expanding operation, a randomizing operation, a combining operation, a scrambling operation, and a hashing operation.

Yet another aspect of the present invention is to provide a method in a computer system for securing information. The method for securing information includes: (a) accessing a master key portion; (b) accessing a session key portion; (c) providing at least a portion of the master key portion and at least a portion of the session key portion to a sub-key generator to create a plurality of sub-keys; (d) accessing a plain text; (e) providing at least a first preselected portion of the sub-keys and the plain text to an encryptor/decryptor to create an intermediate cipher text; (f) providing at least another preselected portion of the sub-keys and the intermediate cipher text to an encryptor/decryptor to create a further intermediate cipher text; and (g) repeating the previous steps (d), (e) and (f) a sufficient number of times so as to create a substantially secure cipher text. It will be appreciated that for each additional process of steps, (d), (e) and (f) that the further intermediate cipher text of step (f) of a previous process is accessed in place of the plain text of step (d) to create the further intermediate cipher text of step (f) for the current process and different preselected portions of the sub-keys are used for each process. Further, it will be appreciated that the sufficient number of times that a process is performed may be a balance between the secureness of the cipher text and the speed at which a plain text may be transformed into a cipher text and back to plain text so as to not impede the operations of a user dealing with the information contained in the plain text. To that end, the number of times a process may be run may range from 1, 2, to 16 or even more so as to strike the correct balance between security and timely accessibility.

Yet another aspect of the present invention is to provide a method in a computer system for securing information. The method for securing information includes: (a) generating a session key portion; (b) accessing a master key portion; (c) providing at least a portion of the master key portion and at least a portion of the session key portion to a sub-key generator to create a plurality of sub-keys; (d) accessing a plain text; (e) providing at least a first preselected portion of the sub-keys and the plain text to an encryptor/decryptor to create an intermediate cipher text; (f) providing at least another preselected portion of the sub-keys and the intermediate cipher text to an encryptor/decryptor to create a further intermediate cipher text; and (g) repeating the previous steps (d), (e) and (f) a sufficient number of times so as to create a substantially secure cipher text, intermediate cipher text of step (f) for the current process and different preselected portions of the sub-keys are used for each process; and (h) transmitting the session key portion and the substantially secure cipher text over a communications link. As previously mentioned it will be appreciated that for each additional process of steps (d), (e) and (f) that the further intermediate cipher text of step (f) of a previous process is accessed in place of the plain text of step (d) to create the further

Yet another aspect of the present invention is to provide a method in a computer system for authorizing access to secure information. The method for authorizing access to secure information includes: (a) accessing a master key portion; (b) accessing a session key portion; (c) providing at least a portion of the master key portion and at least a portion of the session key portion to a sub-key generator to create a plurality of sub-keys; (d) accessing a substantially secure cipher text; (e) providing at least a last preselected portion of the sub-keys and the substantially secure cipher text to an encryptor/decryptor to create a further intermediate cipher text; (f) providing at least another preselected portion of the sub-keys and the further intermediate cipher text to an encryptor/decryptor to create an intermediate cipher text; and (g) repeating the previous steps (d), (e) and (f) a sufficient number of times so as to create a plain text. It will be appreciated that for each additional process of steps (d), (e) and (f) that the intermediate cipher text of step (f) of a previous process is accessed in place of the substantially secure cipher text of step (d) to create the intermediate cipher text of step (f) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a method in a computer system for authorizing access to secure information. The method for authorizing access to secure information includes: (a) accessing a master key portion; (b) receiving a transmission of one or more discrete signals representing a session key portion and a substantially secure cipher text; (c) providing at least a portion of the master key portion and at least a portion of the session key portion to a sub-key generator to create a plurality of sub-keys; (d) providing at least a last preselected portion of the sub-keys and the substantially secure cipher text to an encryptor/decryptor to create a further intermediate cipher text; (e) providing at least another preselected portion of the sub-keys and the further intermediate cipher text to an encryptor/decryptor to create an intermediate cipher text; and (f) repeating the previous steps (d) and (e) a sufficient number of times so as to create a plain text. It will be appreciated that for each additional process of steps (d) and (e) that the intermediate cipher text of step (e) of a previous process is accessed in place of the substantially secure cipher text of step (d) to create the intermediate cipher text of step (e) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a method in a computer system for authorizing access to secure information. The method for authorizing access to secure information includes: (a) providing a key and a public key to a sub-key generator to create a plurality of sub-keys; (b) accessing a substantially secure cipher text; (c) scrambling the substantially secure cipher text using the first preselected portion of the sub-keys to create a further intermediate cipher text; (d) combining a first preselected portion of the sub-keys and a preselected portion of the further intermediate cipher text; (e) expanding the combined preselected portions of the sub-keys and the further intermediate cipher text to create a first intermediate data set; (f) combining the first intermediate data set and the public key to create a second intermediate data set; (g) combining a second preselected portion of the sub-keys and the preselected portion of the further intermediate cipher text to create a scrambling parameter; (h) scrambling the second intermediate data set using the scrambling parameter, a third preselected portion of the sub-keys, and a fourth preselected portion of the sub-keys to create a third intermediate data set; (i) hashing the third intermediate data set; (j) combining the hashed third intermediate data set and the further intermediate cipher text to create an intermediate cipher text; (k) scrambling the intermediate cipher text using the first preselected portion of the sub-keys to create an intermediate cipher text; and (l) repeating steps (b) through (k) a sufficient number of times so as to create a plain text. It will be appreciated that for each additional process of steps (b) through (k) that the intermediate cipher text of step (k) of a previous process is used in place of the further intermediate cipher text of step (b) for a current process and the first preselected portion of the sub-keys of step (c), the second preselected portion of the sub-keys of step (g), and the third preselected portion and the fourth preselected portions of the sub-keys of step (h) are different preselected portions of the sub-keys for each process. As previously mentioned, it will be appreciated that the number of times that the process is performed is the same as the number of times that the process was performed to transform the plain text into the substantially secure cipher text. Further it will be appreciated that the number of times that the processes are performed is the same as the number of times that the processes were performed to transform the plain text into the substantially secure cipher text.

Yet another aspect of the present invention is to provide a method in a computer system for securing information. The method for securing information includes: (a) providing a key and a public key to a sub-key generator to create a plurality of sub-keys; (b) accessing a plain text; (c) combining a first preselected portion of the sub-keys and a preselected portion of the plain text; (d) expanding the combined preselected portions of the sub-keys and plain text to create a first intermediate data set; (e) combining the first intermediate data set and the public key to create a second intermediate data set; (f) combining a second preselected portion of the sub-keys and the preselected portion of the plain text to create a scrambling parameter; (g) scrambling the second intermediate data set using the scrambling parameter, a third preselected portion of the sub-keys, and a fourth preselected portion of the sub-keys to create a third intermediate data set; (h) hashing the third intermediate data set; (i) combining the hashed third intermediate data set and the plain text to create an intermediate cipher text; (j) scrambling the intermediate cipher text using the first preselected portion of the sub-keys to create a further intermediate cipher text; and (k) repeating steps (b) through (j) a sufficient number of times so as to create a substantially secure cipher text. It will be appreciated that for each additional process of steps, (b) through (j) that the further intermediate cipher text of step (f) of a previous process is used in place of the plain text of step (b) for a current process and the first preselected portion of the sub-keys of step (c), the second preselected portion of the sub-keys of step (f), and the third preselected portion and the fourth preselected portions of the sub-keys of step (g) are different preselected portions of the sub-keys for each process. Further, it will be appreciated that the sufficient number of times that a process if performed may be a balance between the secureness of the cipher text and the speed at which a plain text may be transformed into a cipher text and back to plain text so as to not impede the operations of a user dealing with the information contained in the plain text. To that end, the number of times a process may be run may range from 1, 2, to 32 or even more so as to strike the correct balance between security and timely accessibility.

Yet another aspect of the present invention is to provide a method in a computer system for securing information. The method for securing information includes: (a) a sub-key generator comprising a security module capable of accepting as inputs at least a portion of a key and a public key to create a sub-key as an output; (b) an encryptor/decryptor comprising the security module capable of accepting as inputs at least a portion of the sub-key, the public key, and a plain text to create a substantially secure cipher text as an output; and (c) a transmission component capable of transmitting a session key portion of the key and the substantially secure cipher text.

Yet another aspect of the present invention is to provide a method in a computer system for authorizing access to secure information. The method for authorizing access to secure information includes: (a) a transmission component capable of receiving a session key portion of a key and a substantially secure cipher text; (b) a sub-key generator comprising a security module capable of accepting as inputs at least a portion of the key and a public key to create a sub-key as an output; and (c) an encryptor/decryptor comprising the security module capable of accepting as inputs at least a portion of the sub-key, the public key, and a substantially secure cipher text to create a plain text as an output.

Yet another aspect of the present invention is to provide a computer program product. The computer program product includes: (a) a computer useable medium and computer readable code embodied on said computer useable medium for causing a securing of information, the computer readable code comprising: (b) computer readable program code devices configured to cause the computer to effect the accessing of a master key portion; (c) computer readable program code devices configured to cause the computer to effect the accessing of a session key portion; (d) computer readable program code devices configured to cause the computer to effect the providing of at least a portion of the master key portion and at least a portion of the session key portion to a sub-key generator to create a plurality of sub-keys; (e) computer readable program code devices configured to cause the computer to effect the accessing a plain text; (f) computer readable program code devices configured to cause the computer to effect the providing of at least a first preselected portion of the sub-keys and the plain text to an encryptor/decryptor to create an intermediate cipher text; (g) computer readable program code devices configured to cause the computer to effect the providing of at least another preselected portion of the sub-keys and the intermediate cipher text to an encryptor/decryptor to create an further intermediate cipher text; and (h) computer readable program code devices configured to cause the computer to effect the repeating of the previous steps (e), (f) and (g) a sufficient number of times so as to create a substantially secure cipher text, wherein the further intermediate cipher text of step (g) of a previous process is accessed in place of the plain text of step (e) to create the further intermediate cipher text of step (g) for the current process and different preselected portions of the sub-keys are used for each process.

Yet another aspect of the present invention is to provide a computer program product. The computer program product includes: (a) a computer useable medium and computer readable code embodied on said computer useable medium for causing a securing of information, the computer readable code comprising: (b) computer readable program code devices configured to cause the computer to effect the generating of a session key portion; (c) computer readable program code devices configured to cause the computer to effect the accessing of a master key portion; (d) computer readable program code devices configured to cause the computer to effect the providing of at least a portion of the master key portion and at least a portion of the session key portion to a sub-key generator to create a plurality of sub-keys; (e) computer readable program code devices configured to cause the computer to effect the accessing of a plain text; (f) computer readable program code devices configured to cause the computer to effect the providing of at least a first preselected portion of the sub-keys and the plain text to an encryptor/decryptor to create an intermediate cipher text; (g) computer readable program code devices configured to cause the computer to effect the providing of at least another preselected portion of the sub-keys and the intermediate cipher text to an encryptor/decryptor to create a further intermediate cipher text; (h) computer readable program code devices configured to cause the computer to effect the repeating of the previous steps (e), (f) and (g) a sufficient number of times so as to create a substantially secure cipher text; and (i) computer readable program code devices configured to cause the computer to effect the transmitting of the session key portion and the substantially secure cipher text over a communications link. It will be appreciated that for each additional process of steps, (e), (f) and (g) that the further intermediate cipher text of step (g) of a previous process is accessed in place of the plain text of step (e) to create the further intermediate cipher text of step (g) for the current process and different preselected portions of the sub-keys are used for each process

Yet another aspect of the present invention is to provide a computer program product. The computer program product includes: (a) a computer useable medium and computer readable code embodied on said computer useable medium for causing an access to secure information, the computer readable code comprising: (b) computer readable program code devices configured to cause the computer to effect the accessing of a master key portion; (c) computer readable program code devices configured to cause the computer to effect the accessing of a session key portion; (d) computer readable program code devices configured to cause the computer to effect the providing of at least a portion of the master key portion and at least a portion of the session key portion to a sub-key generator to create a plurality of sub-keys; (e) computer readable program code devices configured to cause the computer to effect the accessing a substantially secure cipher text; (f) computer readable program code devices configured to cause the computer to effect the providing of at least a last preselected portion of the sub-keys and the substantially secure cipher text to an encryptor/decryptor to create a further intermediate cipher text; (g) computer readable program code devices configured to cause the computer to effect the providing of at least another preselected portion of the sub-keys and the further intermediate cipher text to an encryptor/decryptor to create an intermediate cipher text; and (h) computer readable program code devices configured to cause the computer to effect the repeating the previous steps (e), (f) and (g) a sufficient number of times so as to create a plain text. It will be appreciated that for each additional process of steps (e), (f) and (g) that the intermediate cipher text of step (g) of a previous process is accessed in place of the substantially secure cipher text of step (e) to create the intermediate cipher text of step (g) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a computer program product. The computer program product includes: (a) a computer useable medium and computer readable code embodied on said computer useable medium for causing an access to secure information by a user, the computer readable code comprising: (b) computer readable program code devices configured to cause the computer to effect the receiving of a master key portion; (c) computer readable program code devices configured to cause the computer to effect the receiving of a transmission of one or more discrete signals representing a session key portion and a substantially secure cipher text; (d) computer readable program code devices configured to cause the computer to effect the providing of at least a portion of the master key portion and at least a portion of the session key portion to a sub-key generator to create a plurality of sub-keys; (e) computer readable program code devices configured to cause the computer to effect the providing of at least a last preselected portion of the sub-keys and the substantially secure cipher text to an encryptor/decryptor to create a further intermediate cipher text; (f) computer readable program code devices configured to cause the computer to effect the providing of at least another preselected portion of the sub-keys and the further intermediate cipher text to an encryptor/decryptor to create an intermediate cipher text; and (g) computer readable program code devices configured to cause the computer to effect the repeating the previous steps (e) and (f) a sufficient number of times so as to create a plain text. It will be appreciated that for each additional process of steps (e) and (f) that the intermediate cipher text of step (f) of a previous process is accessed in place of the substantially secure cipher text of step (e) to create the intermediate cipher text of step (f) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a computer data signal embodied in a transmission medium. The computer data signal embodied in a transmission medium includes: (a) a code segment including instructions for accessing a master key portion; (b) computer readable program code devices configured to cause the computer to effect the accessing of a session key portion; (c) a code segment including instructions for providing at least a portion of the master key portion and at least a portion of the session key portion to a sub-key generator to create a plurality of sub-keys; (d) a code segment including instructions for accessing a plain text; (e) a code segment including instructions for providing at least a first preselected portion of the sub-keys and the plain text to an encryptor/decryptor to create an intermediate cipher text; (f) a code segment including instructions for providing at least another preselected portion of the sub-keys and the intermediate cipher text to an encryptor/decryptor to create a further intermediate cipher text; and (g) repeating the previous steps (d), (e) and (f) a sufficient number of times so as to create a substantially secure cipher text. It will be appreciated that for each additional process of steps, (d), (e) and (f) that the further intermediate cipher text of step (g) of a previous process is accessed in place of the plain text of step (e) to create the further intermediate cipher text of step (g) for the current process and different preselected portions of the sub-keys are used for each process wherein the further intermediate cipher text of step (f) of a previous process is accessed in place of the plain text of step (d) to create the further intermediate cipher text of step (f) for the current process and different preselected portions of the sub-keys are used for each process.

Yet another aspect of the present invention is to provide a computer data signal embodied in a transmission medium. The computer data signal embodied in a transmission medium includes: (a) a code segment including instructions for generating a session key portion; (b) a code segment including instructions for accessing a master key portion; (c) a code segment including instructions for providing at least a portion of the master key portion and at least a portion of the session key portion to a sub-key generator to create a plurality of sub-keys; (d) a code segment including instructions for accessing plain text; (e) a code segment including instructions for providing at least a first preselected portion of the sub-keys and the plain text to an encryptor/decryptor to create an intermediate cipher text; (f) a code segment including instructions for providing at least another preselected portion of the sub-keys and the intermediate cipher text to an encryptor/decryptor to create a further intermediate cipher text; (g) repeating the previous steps (d), (e) and (f) a sufficient number of times so as to create a substantially secure cipher text; and (h) a code segment including instructions for transmitting the session key portion and the substantially secure cipher text over a communications link. It will be appreciated that for each additional process of steps, (d), (e) and (f) that the further intermediate cipher text of step (g) of a previous process is accessed in place of the plain text of step (e) to create the further intermediate cipher text of step (g) for the current process and different preselected portions of the sub-keys are used for each process wherein the further intermediate cipher text of step (f) of a previous process is accessed in place of the plain text of step (d) to create the further intermediate cipher text of step (f) for the current process and different preselected portions of the sub-keys are used for each process.

Yet another aspect of the present invention is to provide a computer data signal embodied in a transmission medium. The computer data signal embodied in a transmission medium includes: (a) a code segment including instructions for accessing a master key portion; (b) a code segment including instructions for accessing a session key portion; (c) a code segment including instructions for providing at least a portion of the master key portion and at least a portion of the session key portion to a sub-key generator to create a plurality of sub-keys; (d) a code segment including instructions for accessing a substantially secure cipher text; (e) a code segment including instructions for providing at least a last preselected portion of the sub-keys and the substantially secure cipher text to an encryptor/decryptor to create a further intermediate cipher text; (f) a code segment including instructions for providing at least another preselected portion of the sub-keys and the further intermediate cipher text to an encryptor/decryptor to create an intermediate cipher text; and (g) a code segment including instructions for repeating the previous steps (d), (e) and (f) a sufficient number of times so as to create a plain text. It will be appreciated that for each additional process of steps (d), (e) and (f) that the intermediate cipher text of step (f) of a previous process is accessed in place of the substantially secure cipher text of step (d) to create the intermediate cipher text of step (f) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a computer data signal embodied in a transmission medium. The computer data signal embodied in a transmission medium includes: (a) a code segment including instructions for accessing a master key portion; (b) a code segment including instructions for receiving a transmission of one or more discrete signals representing a session key portion and a substantially secure cipher text; (c) a code segment including instructions for providing at least a portion of the master key portion and at least a portion of the session key portion to a sub-key generator to create a plurality of sub-keys; (d) a code segment including instructions for providing at least a last preselected portion of the sub-keys and the substantially secure cipher text to an encryptor/decryptor to create a further intermediate cipher text; (e) a code segment including instructions for providing at least another preselected portion of the sub-keys and the further intermediate cipher text to an encryptor/decryptor to create an intermediate cipher text; and (f) a code segment including instructions for repeating the previous steps (d) and (e) a sufficient number of times so as to create a plain text. It will be appreciated that for each additional process of steps (d) and (e) that the intermediate cipher text of step (e) of a previous process is accessed in place of the substantially secure cipher text of step (d) to create the intermediate cipher text of step (e) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is for securing information in an Internet transaction. The method for securing information in an Internet transaction includes: (a) accessing a master key portion; (b) accessing a session key portion; (c) providing at least a portion of the master key portion and at least a portion of the session key portion to a sub-key generator to create a plurality of sub-keys; (d) accessing a plain text; (e) providing at least a first preselected portion of the sub-keys and the plain text to an encryptor/decryptor to create an intermediate cipher text; (f) providing at least another preselected portion of the sub-keys and the intermediate cipher text to an encryptor/decryptor to create a further intermediate cipher text; and (g) repeating the previous steps (d), (e) and (f) a sufficient number of times so as to create a substantially secure cipher text. It will be appreciated that for each additional process of steps, (d), (e) and (f) that the further intermediate cipher text of step (g) of a previous process is accessed in place of the plain text of step (e) to create the further intermediate cipher text of step (g) for the current process and different preselected portions of the sub-keys are used for each process wherein the further intermediate cipher text of step (f) of a previous process is accessed in place of the plain text of step (d) to create the further intermediate cipher text of step (f) for the current process and different preselected portions of the sub-keys are used for each process.

Yet another aspect of the present invention is for securing information in an Internet transaction. The method for securing information in an Internet transaction includes: (a) generating a session key portion; (b) accessing a master key portion; (c) providing at least a portion of the master key portion and at least a portion of the session key portion to a sub-key generator to create a plurality of sub-keys; (d) accessing a plain text; (e) providing at least a first preselected portion of the sub-keys and the plain text to an encryptor/decryptor to create an intermediate cipher text; (f) providing at least an other preselected portion of the sub-keys and the intermediate cipher text to an encryptor/decryptor to create a further intermediate cipher text; (g) repeating the previous steps (d), (e) and (f) a sufficient number of times so as to create a substantially secure cipher text; and (i) transmitting the session key portion and the substantially secure cipher text over a communications link. It will be appreciated that for each additional process of steps, (d), (e) and (f) that the further intermediate cipher text of step (g) of a previous process is accessed in place of the plain text of step (e) to create the further intermediate cipher text of step (g) for the current process and different preselected portions of the sub-keys are used for each process, wherein the further intermediate cipher text of step (f) of a previous process is accessed in place of the plain text of step (d) to create the further intermediate cipher text of step (f) for the current process and different preselected portions of the sub-keys are used for each process.

Yet another aspect of the present invention is to provide a method for an Internet transaction involving accessing secure information. The method for method for an Internet transaction involving accessing secure information includes: (a) accessing a master key portion; (b) accessing a session key portion; (c) providing at least a portion of the master key portion and at least a portion of the session key portion to a sub-key generator to create a plurality of sub-keys; (d) accessing a substantially secure cipher text; (e) providing at least a last preselected portion of the sub-keys and the substantially secure cipher text to an encryptor/decryptor to create a further intermediate cipher text; (f) providing at least another preselected portion of the sub-keys and the further intermediate cipher text to an encryptor/decryptor to create an intermediate cipher text; and (g) repeating the previous steps (d), (e) and (f) a sufficient number of times so as to create a plain text. It will be appreciated that for each additional process of steps (d), (e) and (f) that the intermediate cipher text of step (f) of a previous process is accessed in place of the substantially secure cipher text of step (d) to create the intermediate cipher text of step (f) for the current process and different preselected portions of the sub-keys are used for each process. Further it will be appreciated that the number of times that the processes are performed is the same as the number of times that the processes were performed to transform the plain text into the substantially secure cipher text.

Yet another aspect of the present invention is to provide a method for an Internet transaction involving accessing secure information. The method for an Internet transaction involving accessing secure information includes: (a) accessing a master key portion;

(b) accessing a session key portion; (c) providing at least a portion of the master key portion and at least a portion of the session key portion to a sub-key generator to create a plurality of sub-keys; (d) accessing a substantially secure cipher text; (e) providing at least a last preselected portion of the sub-keys and the substantially secure cipher text to an encryptor/decryptor to create a further intermediate cipher text; (f) providing at least another preselected portion of the sub-keys and the further intermediate cipher text to an encryptor/decryptor to create an intermediate cipher text; (g) repeating the previous steps (d), (e) and (f) a sufficient number of times so as to create a plain text; and (i) transmitting the session key portion and the substantially secure cipher text over a communications link. It will be appreciated that for each additional process of steps (d), (e) and (f) that the intermediate cipher text of step (f) of a previous process is accessed in place of the substantially secure cipher text of step (d) to create the intermediate cipher text of step (f) for the current process and different preselected portions of the sub-keys are used for each process. Further it will be appreciated that the number of times that the processes are performed is the same as the number of times that the processes were performed to transform the plain text into the substantially secure cipher text.

These and other aspects of the present invention will become apparent to those skilled in the art after a reading of the following description of the preferred embodiment when considered with the drawings.

### BRIEF DESCRIPTION OF THE DRAWINGS

FIG. 1 is a state diagram illustrating a generalized security module according to an aspect of an embodiment of the present invention;

FIG. 2 is a graphical representation of a key generator(s) and a key exchange in a system for securing information capable of using the generalized security module of FIG. 1 according to an aspect of an embodiment of the present invention;

FIG. 3 is a graphical representation of an encryptor capable of converting a plain text to a cipher text in a system for securing information capable of using the generalized security module of FIG. 1 according to an aspect of an embodiment of the present invention;

FIG. 4 is a graphical representation of an encryptor/decryptor and a cipher text exchange in a system for securing information capable of using the generalized security module of FIG. 1 according to an aspect of an embodiment of the present invention;

FIG. 5 is a graphical representation of a decryptor capable of converting a cipher text to a plain text in a system for securing information capable of using the generalized security module of FIG. 1 according to an aspect of an embodiment of the present invention;

FIG. 6 is a graphical representation of a scrambler capable of use in the generalized security module of FIG. 1 according to an aspect of an embodiment of the present invention;

FIG. 7 is a graphical representation of a permutator capable of use in the scrambler of FIG. 6 according to an aspect of an embodiment of the present invention;

FIG. 8 is a graphical representation of a hasher of use in the generalized security module of FIG. 1 according to an aspect of an embodiment of the present invention;

FIG. 9 is a graphical representation of a scrambler (message dependent) capable of use in the hasher of FIG. 8 according to an aspect of an embodiment of the present invention;

FIG. 10 is an alternative graphical representation of a key generator(s) and a key exchange in a system for securing information capable of using the generalized security module of FIG. 1 according to an aspect of an embodiment of the present invention;

FIG. 11 is an alternative graphical representation of a encryptor capable of converting a plain text to a cipher text in a system for securing information capable of using the generalized security module of FIG. 1 according to an aspect of an embodiment of the present invention;

FIG. 12 is an alternative graphical representation of an encryptor/decryptor and a cipher text exchange in a system for securing information capable of using the generalized security module of FIG. 1 according to an aspect of an embodiment of the present invention;

FIG. 13 is an alternative graphical representation of a decryptor capable of converting a cipher text to a plain text in a system for securing information capable of using the generalized security module of FIG. 1 according to an aspect of an embodiment of the present invention;

FIG. 14 is a graphical representation of a generalized security module according to an aspect of an embodiment of the present invention;

FIG. 15 is a graphical representation of a scrambler (permutator) capable of use in generalized security module of FIG. 1 and/or with a key generator of FIG. 10 and/or with an encryptor/decryptor of FIG. 12 according to an aspect of an embodiment of the present invention;

FIG. 16a is another alternative graphical representation of a key generator(s) and/or an encryptor/decryptor according to an aspect of an embodiment of the present invention;

FIG. 16b is a graphical representation of the key generator(s) aspect of FIG. 16a;

FIG. 16c is a graphical representation of the encryptor/decryptor aspect of FIG. 16a;

FIG. 17 is a graphical representation of a scrambler capable of use in the key generator(s) of FIGS. 16a and 16b and FIG. 21 according to an aspect of an embodiment of the present invention;

FIG. 18 is a graphical representation of a permutator capable of use in the scrambler of FIG. 17 according to an aspect of an embodiment of the present invention;

FIG. 19 is a graphical representation of a hasher capable of use in the a generalized security module of FIG. 15 according to an aspect of an embodiment of the present invention;

FIG. 20 is a graphical representation of a message dependent capable of use in the generalized security module of FIG. 15 according to an aspect of an embodiment of the present invention;

FIG. 21 is a graphical representation of an encryptor/decryptor and a cipher text exchange in a system for securing information capable of using the generalized security module of FIG. 15 according to an aspect of an embodiment of the present invention; and

FIG. 22 is a graphical representation of a permutator capable of use in the scrambler of FIG. 17 according to an aspect of an embodiment of the present invention.

### DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

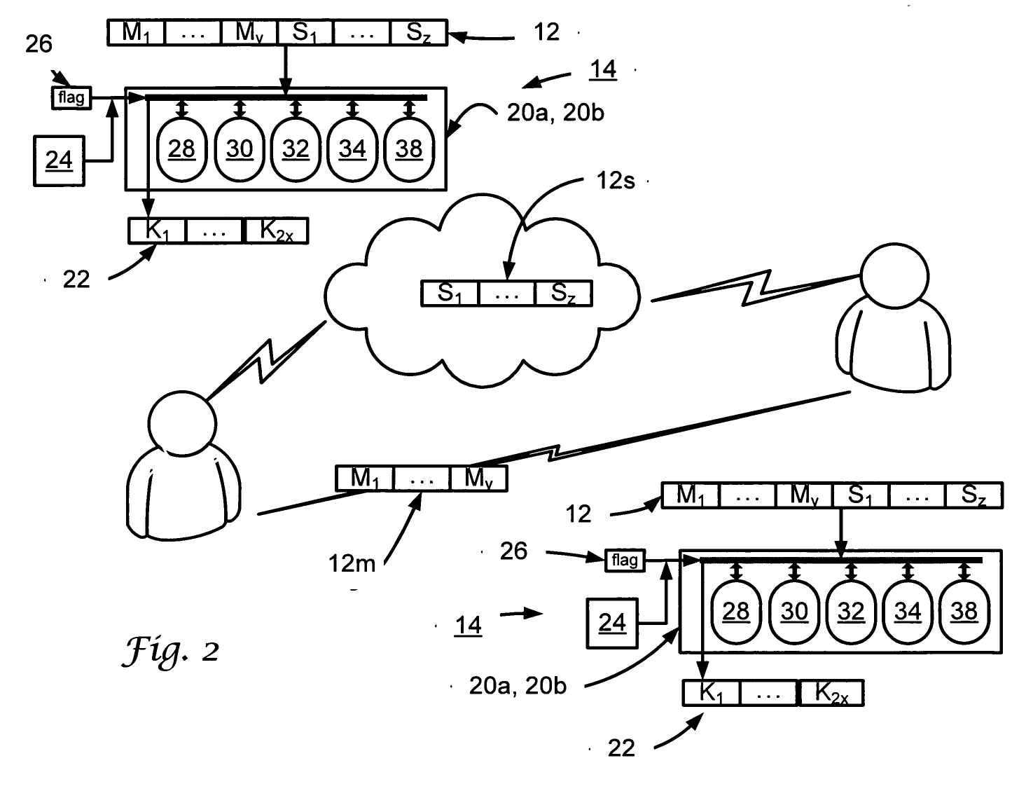

Referring now to the drawings in general, and FIGS. 2, 4, 10, 12, 16a, and 21 in particular, it will be understood that the illustrations are for the purpose of describing one or more aspects and/or embodiments of the invention and are not intended to limit the invention thereto. As seen in FIGS. 2, 4, 10, 12, 16a, and 21, a system for securing information, generally designated 10 (information securing system 10 or system 10), is shown according to the present invention. The system 10 includes a key 12, a sub-key generator 14, and an encryptor/decryptor 18. The sub-key generator 14 includes a first security module 20a. At least a portion of the key 12 is an input to the first security module 20a of the sub-key generator 14, and a sub-key 22 is an output. The encryptor/decryptor 18 includes a second security module 20b. At least a portion of the sub-key 22 is an input to second security module 20b, and a cipher text is an output. In an aspect of an embodiment of an information securing system 10, the first security module 20a and second security module 20b are substantially the same.

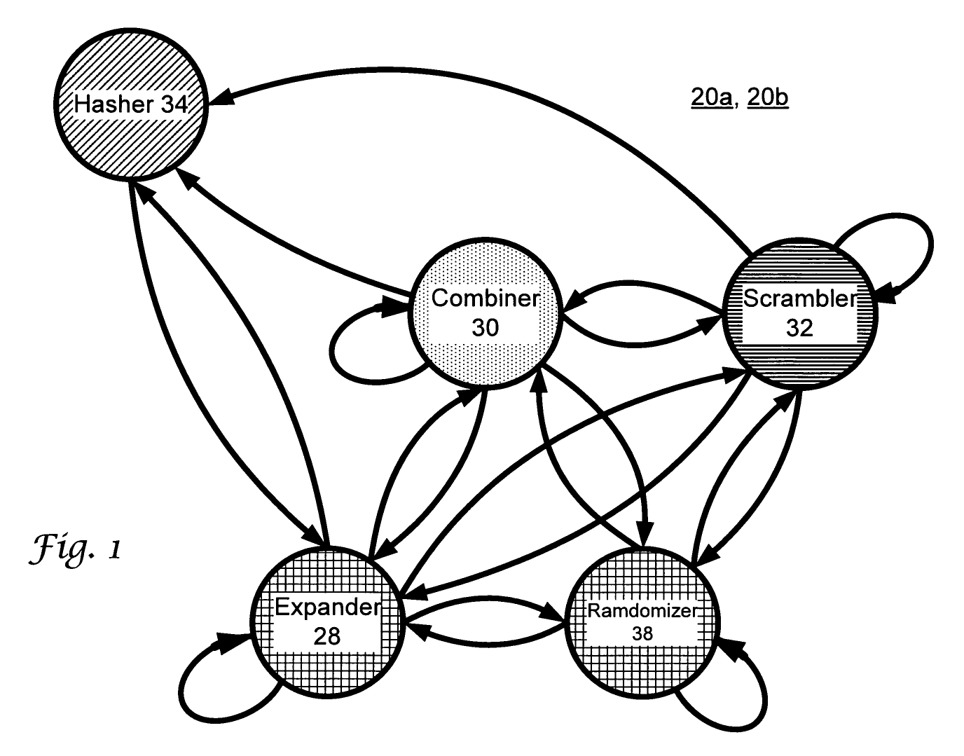

Turning now to FIG. 1, there is depicted a state diagram illustrating a generalized security module 20a, 20b according to an aspect of an embodiment of the present invention. Such a security module 20a, 20b is useable in an information securing system 10 either as a sub-key generator 14, an encryptor/decryptor 18, or a sub-key generator 14 and encryptor/decryptor 18. Such a security module 20a, 20b can include in linkable arrangement an expander 28, a combiner 30, a scrambler 32, and a hasher 34. Further, such a security module 20a, 20b can include in linkable arrangement a randomizer 38.

A randomizer 38 can be any of the type known, such as, for example, without limitation, any one of a pseudo random number generator (PRNG), a linear congruent generator, a nonlinear congruent generator, linear feedback shift register, an A5 number generator, a Hughes number generator, a Nanoteq number generator, Rambutan random number generator, an additive random number generator, a Gifford random number generator, an algorithm M random number generator, a PKZIP random number generator, a table of random numbers, or any combination of any two or more of the preceding.

A pseudo random generator (PRNG) can be a multiple stage pseudo random generator (MSPRNG), such as, for example, without limitation, a two stage pseudo random generator (TSPRNG). Alternatively, a pseudo random number generator (PRNG) can be any one of a Yarrow type random number generator, an ISAAC type random number generator an ANSI standard type random number generator, or any combination of any two or more of the preceding.

A combiner 30 of security module 20a, 20b can be any one of a Galois field (or finite field) operator, an XOR (or exclusive o) operator, or a Galois field operator and an XOR (exclusive o) operator. Examples of suitable Galois fields (or finite field) include, for example, without limitation, any one of a prime order Galois field (or finite field) operator, an order of the power of two Galois field (or finite field) operator, or a prime order Galois field (or finite field) operator and an order of the power of two Galois field (or finite field) operators. When a combiner 30 of security module 20a, 20b is a Galois field (or finite field) operator, the Galois field can range from 2 to the processor size limit. To that end, an example of a Galois field is a Reed Solomon defined Galois field.

When a combiner 30 of security module 20a, 20b is a Galois field (or finite field) operator, it can be any one of addition (+), subtraction (−), elementwise multiplication (.*), matrix multiplication (*), elementwise left division (./), elementwise right division (.\), matrix left division (/), matrix right division (\), elementwise exponentiation (.̂), elementwise logarithm (log( )), exponentiation of a square Galois matrix by a scalar integer (̂), or any combination of any two or more of the preceding.

A scrambler 32 can be any one of at least one bit-shifter 40, at least one permutator, or at least one bit-shifter 40 and at least one permutator 42. A scrambler 32 can be represented by

S_{α,β}=f(αp,βs),

where S_{α,β} is a parameterization of a permutator 42 by α and a bit-shifter 40 by β. Thus for example, a zero bit shifter can be represented by

S_{α,0}=f(αp,0),

while a zero permutator can be represented by

S_{0,β}=f(0,βs).

An example of a bit-shifter 40 is a circular-bit-shifter while an example of a permutator 42 is at least one block-wise permutator 42.

An expander 28 is capable of taking a smaller or seed value and creating a larger array or matrix. To that end, an expander 28 can be any one of a pseudo random number generator (PRNG), a linear congruent generator, a nonlinear congruent generator, a linear feedback shift register, an A5 number generator, a Hughes number generator, a Nanoteq number generator, a Rambutan random number generator, an additive random number generator, a Gifford random number generator, an algorithm M random number generator, a PKZIP random number generator, a table of random numbers, or any combination of any two or more of the preceding. A pseudo random generator (PRNG) can be a multiple stage pseudo random generator (MSPRNG), such as, for example, without limitation, a two stage pseudo random generator (TSPRNG). Alternatively, a pseudo random number generator (PRNG) can be any one of a Yarrow type random number generator, an ISAAC type random number generator, an ANSI standard type random number generator, or any combination of any two or more of the preceding.

A hasher 34 comprises any one of a one-way hasher, a collision resistant hasher (a collision-free hasher), a trapdoor one-way hasher, or a hasher from a class of universal hasher, or any combination of any of the preceding. Examples of types of hasher 34 can include any one of a Gost type hasher, a HAS type hasher, a HAVAL type hasher, an MD type hasher, an N-Hash type hasher, a PANAMA type hasher, a SHA type hasher, a Snefru type hasher, a Tiger type hasher, a VEST type hasher, a WHIRLPOOL type hasher, or any combination of any of the preceding. Examples of MD type hashers include, without limitation, any one of an MD2 type hasher, an MD4 type hasher, an MD5 type hasher, a RIPEMD type hasher, or any combination of any of the preceding. Examples of RIPEMD type hashers include, without limitation, any one of a RIPEMD-160 type hasher, a RIPEMD-128 type hasher, a RIPEMD-256 type hasher, a RIPEMD-320 type hasher, or any combination of any of the preceding. Examples of SHA type hashers include, without limitation, any one of a SHA-0 type hasher, a SHA-1 type hasher, a SHA-224 type hasher, a SHA-256 type hasher, a SHA-384 type hasher, and a SHA-512 type hasher, or any combination of any of the preceding. Examples of Tiger type hashers include, without limitation, any one of a Tiger-192 type hasher, a Tiger-160 type hasher, a Tiger-128 type hasher, a Tiger2 type hasher, or any combination of any of the preceding. Examples of a VEST type hashers include, without limitation, any one of a VEST-4, a VEST-8, a VEST-16, a VEST-32, an AES-128, or any combination of any of the preceding. An example of a PANAMA type hasher includes, without limitation, a RadioGatún type hasher.

In an aspect of an embodiment, an information securing system 10 can further include a public key 24. In an aspect, such public key 24 can act as a fingerprint for authenticating a cipher text. To that end, a fingerprint can be a representation of a physical aspect of an entity, such as, for example, without limitation, a representation of an intrinsic physical trait of a human. Examples of intrinsic physical traits of a human include, without limitation, any one of a representation of the markings of the inner surface of the last joint of a digit of a human hand, a representation of the measurements of a human hand, a representation of a retina of an eye, a representation of an iris of an eye, a representation of a facial pattern, a representation of a portion of the deoxyribonucleic acid (DNA), or any combination of two or more of any of the preceding.

Alternatively or in addition, a fingerprint can be a representation of a digital representation of an aspect of an entity, such as, without limitation, an aspect of an entity comprises a digital identity. Examples of digital identity include, without limitation, one or more digital identifiers comprising any one of an omnidirectional identifier, an unidirectional identifier, a resolvable identifier, a non-resolvable identifier, or any combination of two or more of any of the preceding.

In an aspect of an embodiment, an entity can be one or more components of a telecommunication system that can include, without limitation, any one of a telegraph network, a telephone network, a radio system, a radio network, television system, television network, a computer network, satellite system, satellite network, or any combination of two or more of any of the preceding.

Another alternative, or in addition, a fingerprint can be a digital representation of at least a portion of electromagnetic spectrum that can include, without limitation, any one of a portion of the visible spectrum or optical spectrum, a portion of the audio spectrum, or a portion of the visible or optical spectrum, a portion of the audio spectrum, or any combination of two or more of any of the preceding. In regard to a portion of the visible spectrum, it can include, without limitation, any one of a still image, a sequence of still images, or a still image and a sequence of still images. In regard to a sequence of still images, it can include, without limitation, at least a portion of a video, such as, without limitation, a stream from about one second or longer. (an N-second stream).

In regard to a portion of the audio spectrum, it can be any one of a portion of the audio spectrum found in nature, a portion of the audio spectrum synthesis by humans, or a portion of the audio spectrum found in nature and a portion of the audio spectrum synthesis by humans. An example of an audio spectrum synthesis by humans includes music. Examples of audio spectrum found in nature include, without limitation, any one of speech, an animal sound, or speech and an animal sound.

Returning now to FIGS. 1, 2, 3, 5, 10, 11, 13, and 14, in an aspect of an embodiment of an invention, a first security module 20a and the second security module 20b are substantially the same. A key 12 is supplied to a security module 20a, 20b when configured as a sub-key generator 14. Such key 12 can include a master key 12m and a session key 12s. In turn, a master key 12m can include a first plurality of words, and a session key 12s can include a second plurality of words. A number of the first plurality and a second number second plurality of words can be any one of different or the same. A first plurality and second plurality of words can range in size from machine word size to machine processor size. A number of alternatives are available for word size including, without limitation, any one of:
(a) a size of each of the first plurality words comprises any one of a different word size, a same word size, or a combination of a different and a same word size;
(b) a size of each of the second plurality words comprises any one of a different word size, a same word size, or a combination of a different and a same word size; or
(c) a size of each of the first plurality words and the second plurality words comprises any one of a different word size, a same word size, or a combination of a different and a same word size.

In an aspect of an embodiment, a first plurality and second plurality of words can be at least a 4 bit word size, while in another aspect of an embodiment, a first plurality and second plurality of words can be at least an 8 bit word size.

In combination, FIGS. 1 through 9 illustrate aspects of embodiments of an information securing system 10, a security module 20a, 20b, a method for securing information, and an algorithm for securing information. Namely, the state diagram of FIG. 1 illustrates in linkable arrangement an expander 28, a combiner 30, a scrambler 32, a hasher 34, and a randomizer 38.

The graphical representation in FIG. 2 illustrates sub-key 22 (e.g., K₁ K₂, K₃ . . . K₂ₓ) generation using key 12 (e.g., master keys 12m {M₁, M₂, M₃ . . . M_{y}} and session keys 12s {S₁, S₂, S₃ . . . S_{z}} when flag 26 sets security module 20a, 20b to key generator 14 mode. Also illustrated is a key exchange including a master key 12m {M₁, M₂, M₃ . . . M_{y}} exchange and a session key 12s {S₁, S₂, S₃ . . . S_{z}} exchange. It is desirable that these exchanges be done in secure manner, for example, person to persons, as illustrated for the master key 12m {M₁, M₂, M₃ . . . M_{y}} exchange; over the internet, as illustrated for the session key 12s {S₁, S₂, S₃ . . . S_{z}} exchange; or any other manner that is capable of maintaining the integrity of key 12. An additional level of security can be realized through the use of a public key 24 that can, but need not be public but rather is designated as public as it can exists in or be obtained from the public domain. Master keys 12m and public key 24 can be exchanged at a lesser frequency than session keys 12s {S₁, S₂, S₃ . . . S_{z}}, which can be exchanged each session.

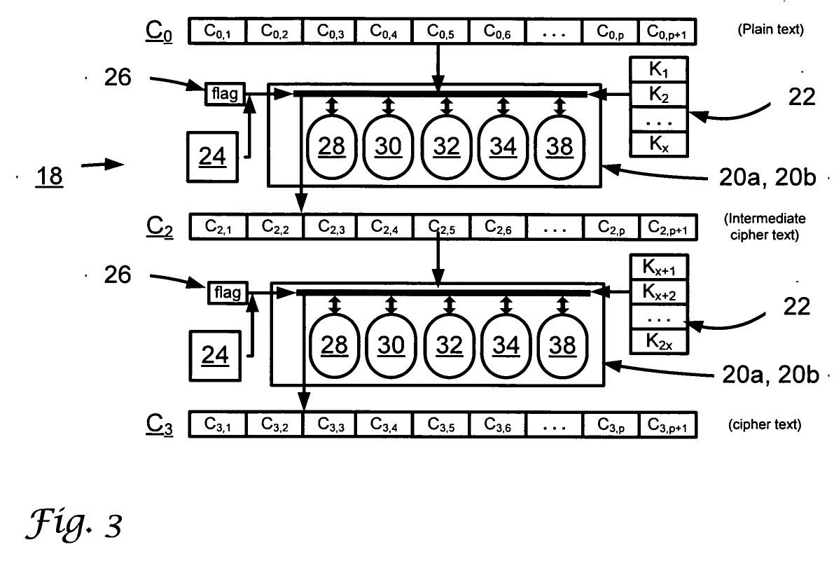

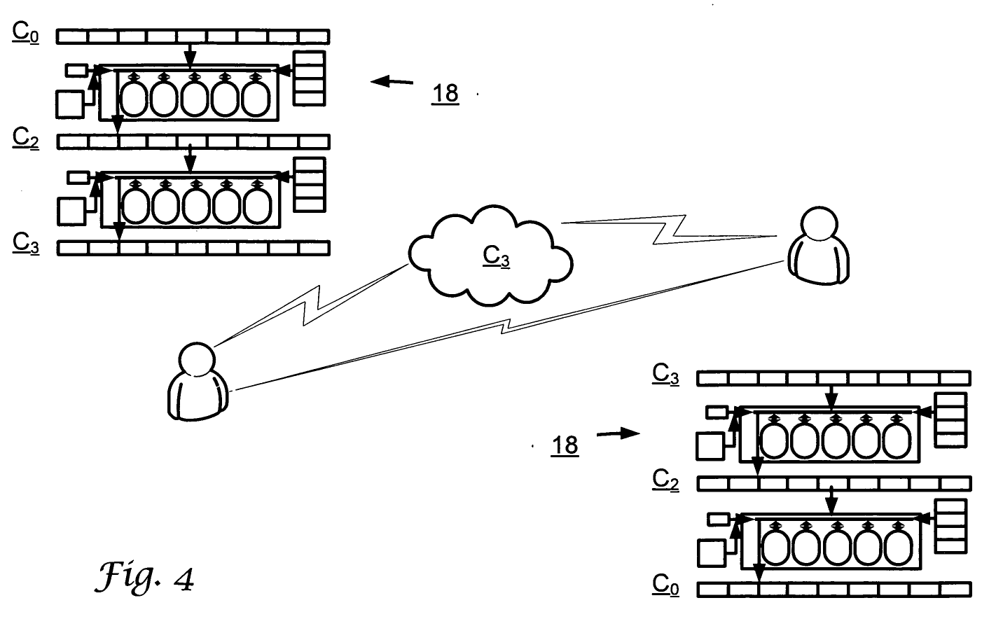

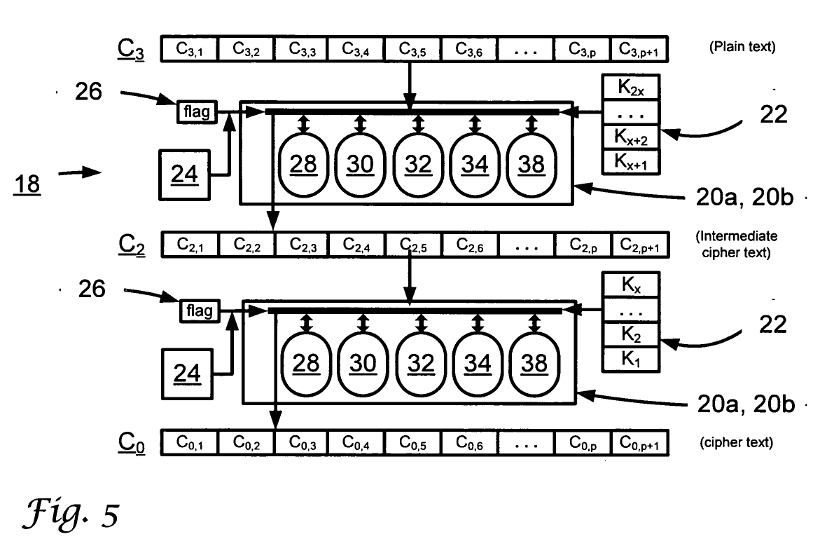

The graphical representation in FIG. 3 illustrates an encryption of plain text C₀ {C_{0,1}, C_{0,2}, C_{0,3} . . . C_{0,p}, C_{0,p+1}} to an intermediate cipher text C₂ {C_{2,1}, C_{2,2}, C_{2,3} . . . C_{2,p}, C_{2,p+1}} and then to a cipher text C₃ {C_{3,1}, C_{3,2}, C_{3,3} . . . C_{3,p}, C_{3,p+1}} using sub-key 22 {e.g., K₁, K₂, K₃ . . . K₂ₓ} and public key 24 when flag 26 sets security module 20a, 20b to encryptor/decryptor 18 mode. The graphical representation in FIG. 4 illustrates the cipher text C₃ {C_{3,1}, C_{3,2}, C_{3,3} . . . C_{3,p}, C_{3,p+1}} exchange in an information securing system 10. The graphical representation in FIG. 5 illustrates decryption of the cipher text C₃ {C_{3,1}, C_{3,2}, C_{3,3} . . . C_{3,p}, C_{3,p+1}} to the intermediate cipher text C₂ {C_{2,1}, C_{2,2}, C_{2,3} . . . C_{2,p}, C_{2,p+1}} and then to the plain text C₀ {C_{0,1}, C_{0,2}, C_{0,3} . . . C_{0,p}, C_{0,p+1}} using sub-key 22 {e.g., K₂ₓ . . . K₃, K₂ K₁} and public key 24 when flag 26 sets security module 20a, 20b to decryption and encryptor/decryptor 18 mode.

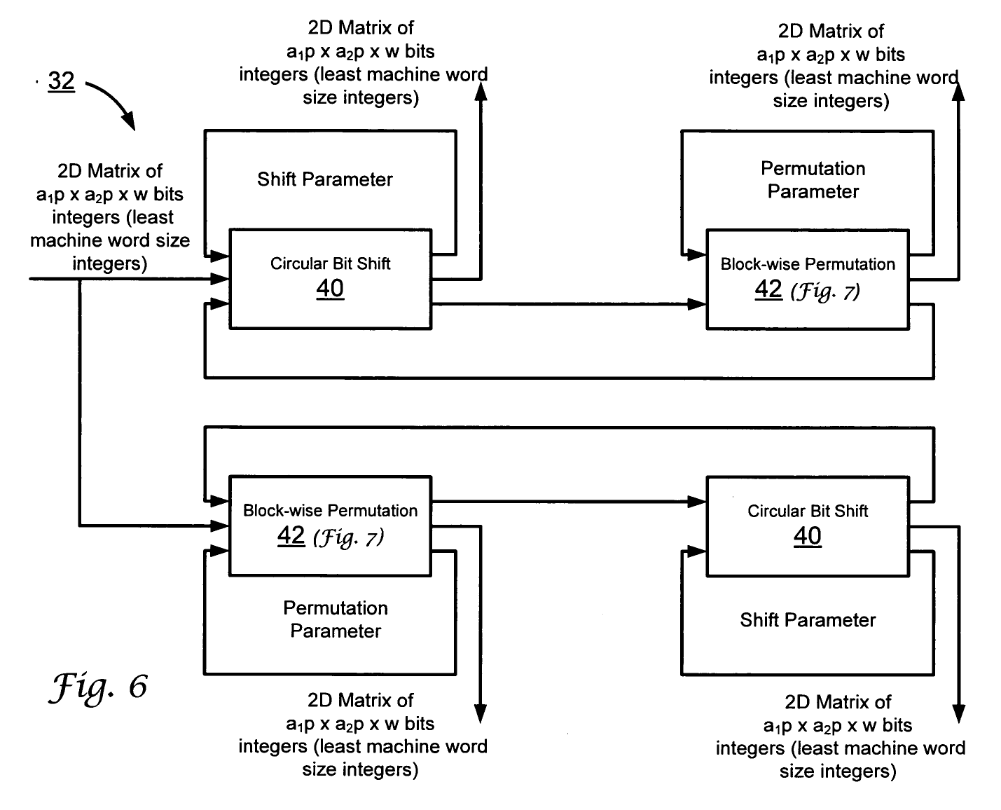

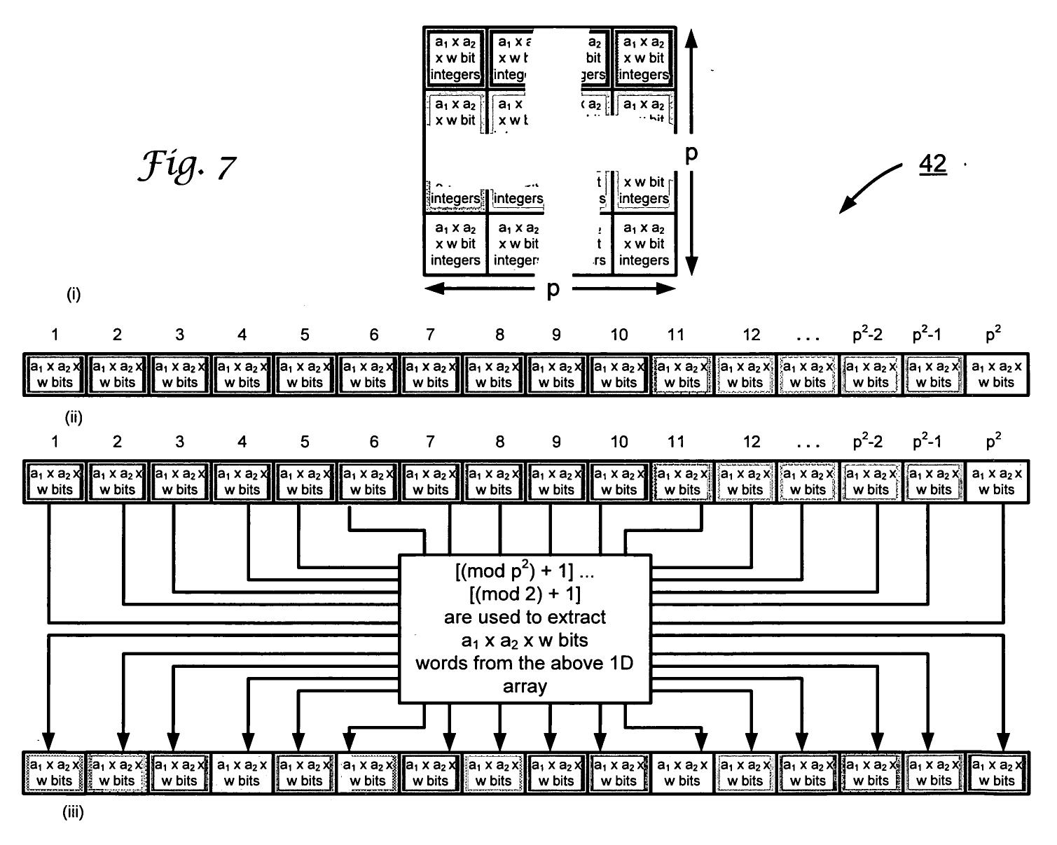

The graphical representation in FIG. 6 illustrates a scrambling of a 2D matrix of a₁p×a₂p×w bit integers (e.g., capable of being up to machine processors size) using a scrambler 32 capable of being represented by Sα,_{β}=f(αp, βs), where Sα,_{β} is a parameterization of a permutator 42 by α and a bit-shifter 40 by β. The graphical representation in FIG. 7 illustrates a transformation of a 2D p×p matrix of a₁×a₂×w bit integers to a 1D matrix of p²×(a₁×a₂×w bit integer) words followed by a permutation of the a₁×a₂×w bit integer words using a [mod(p²)+1] operator in a permutator 42 capable of use in the scrambler 32 of FIG. 6.

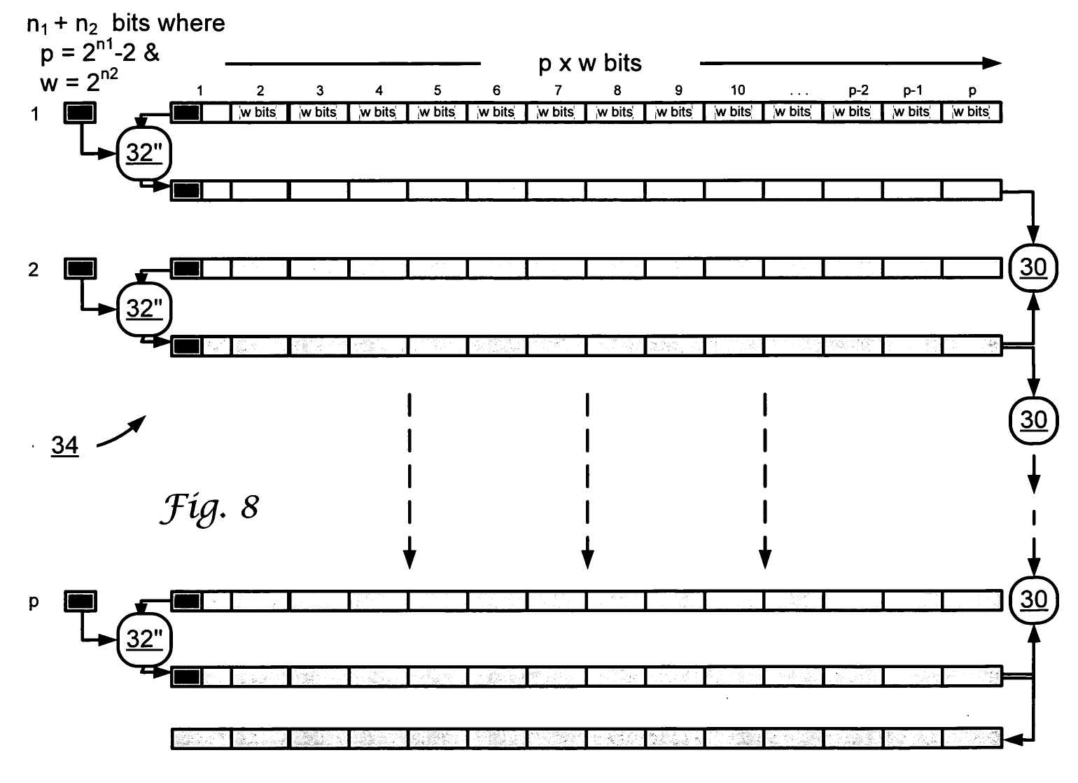

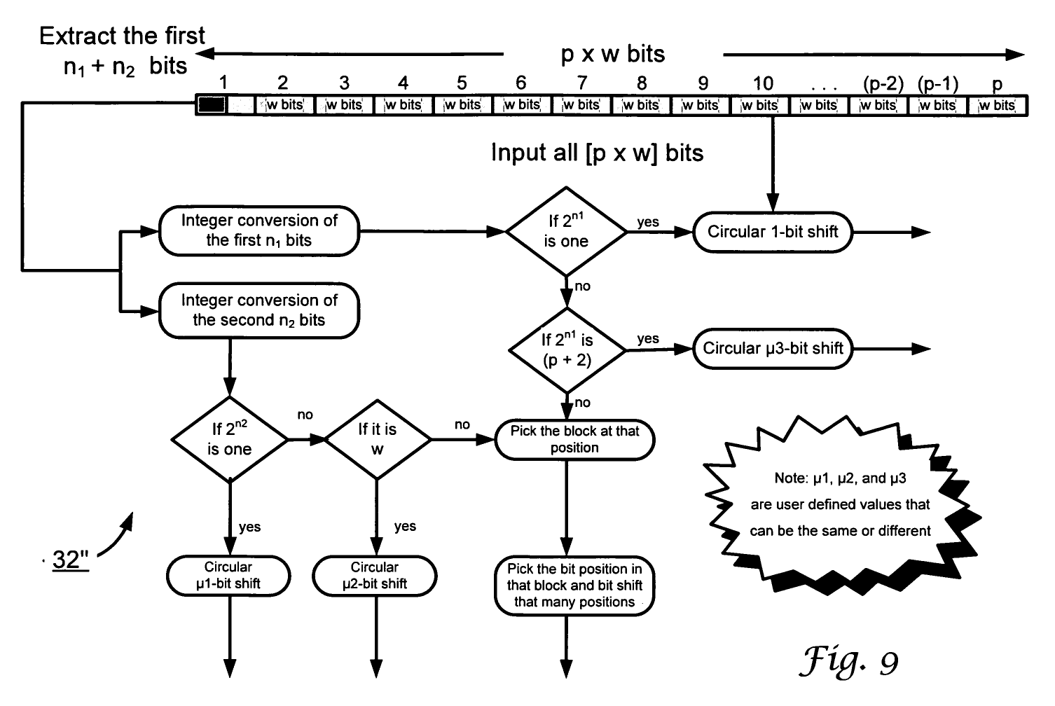

The graphical representation in FIG. 8 illustrates hashing of p²×w bits to p×w bits {where n₁+n₂, p=(2⁽ⁿ¹⁾−2) and w=2⁽ⁿ²⁾}. As can be seen in FIG. 8, the p×w bits are divided in each row into p×w-bit blocks, and the first n₁+n₂ bits then can be used to scramble the entire p×w bits. The first n₁ bits are used to select a block number, and the next n₂ bits are used to select a bit position in that block. Then, the entire p×w bits will be circularly bit shifted with respect to that bit position. The process of this bit shift is denoted by scrambler 32″ and is presented in FIG. 9. This process is applied to all of the p×w bits entries in the rows and run through combiner 30 column (bit) by column (bit) to obtain a new arrangement of the p×w bits.

The graphical representation in FIG. 9 illustrates a scrambler 32″ (e.g., which may be message dependent) capable of use in the hasher 34 of FIG. 8 according to an aspect of an embodiment of the present invention. The scrambler 32″ scrambles the entire input bit set blockwise using p×w bit block size to generate a hash code of p×w bits.

In combination, FIGS. 1 and 10 through 15 illustrate aspects of embodiments of an information securing system 10, a security module 20a, 20b, a method for securing information, and an algorithm for securing information. As noted, the state diagram of FIG. 1 illustrates in linkable arrangement an expander 28, a combiner 30, a scrambler 32, a hasher 34, and a randomizer 38.

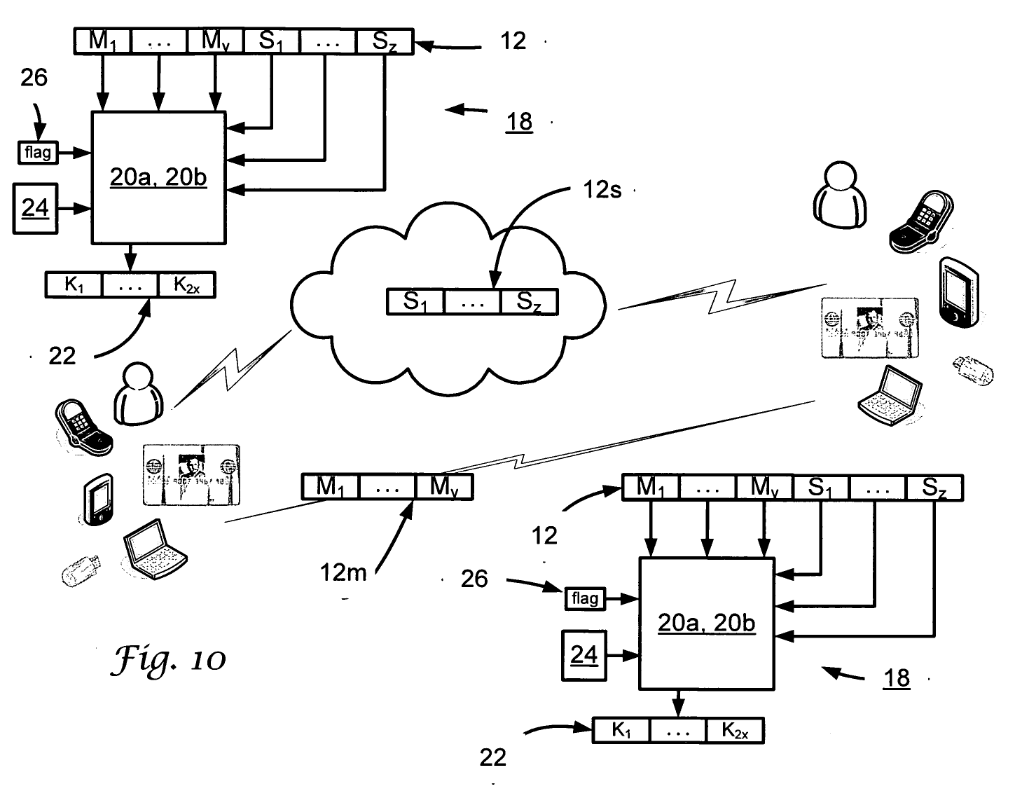

The graphical representation in FIG. 10 illustrates sub-key 22 {e.g., K₁, K₂, K₃ . . . K₂ₓ} generation using key 12 (e.g., master keys 12m {M₁, M₂, M₃ . . . M_{y}} and session keys 12s {S₁, S₂, S₃ . . . S_{z}}) when flag 26 sets security module 20a, 20b to key generator 14 mode. Also illustrated are various aspects of an embodiment of the invention concerning an exchange that may be among and/or within a variety of devices or components of devices working with data storage and/or data exchange. For example, without limitation, such devices may be any one of a telephonic device, a computer device, a television type device, a smart card (a.k.a chip card, or integrated circuit card (ICC)), a sensor devices for wireless sensor networks (e.g., ATmega 128, ATmega 128L), a storage component, or any combination of any of the preceding. Some examples of suitable devices and/or components of devices, without limitation, include those disclosed in “The Digital Consumer Technology Handbook: A Comprehensive Guide to Devices, Standards Future Directions and Programmable Logic Solutions,” written by Amit Dhir and published by the Reed Elsevier Group plc with a copyright date of 2004. Some examples of telephonic devices, without limitation, include any one of a facsimile device, a voice phone device, a screen phone device, a videophone device, mobile phone device, web terminal device, web pad device, computer device, or any combination of any of the preceding. Some examples of computer devices, without limitation, include any one of a personal computer device (e.g., any one of a desktop computer, a notebook computer, a gaming device, or any combination of any of the preceding), a hand-held type device (e.g., without limitation, personal digital assistant (PDA)), or any combination of any of the preceding. For example, without limitation, such components of devices may be any one of a primary storage component, secondary component, off-line storage component, tertiary and database storage component, network storage component. Some characteristics of such storage components include, without limitation, volatility of information, ability to access non-contiguous information, ability to change information, addressability of information, and capacity and performance. Technologies include devices and media without limitation, for example, magnetic storage, semiconductor storage, optical disc storage, magneto-optical disc storage, ultra density optical disc storage, optical jukebox storage, tape, punch cards, cathode ray tube vacuum tube, sound waves in a substance, phase change in material, holographic storage, molecular memory, or any combination of any of the preceding.

Also illustrated in FIG. 10 is a key exchange including master key 12m {M₁, M₂, M₃ . . . M_{y}} exchange and a session key 12s {S₁, S₂, S₃ . . . S_{z}} exchange. It is desirable that these exchanges be done in a secure manner, for example, person to persons, as illustrated for the master key 12m {M₁, M₂, M₃ . . . M_{y}} exchange; over the internet, as illustrated for the session key 12s {S₁, S₂, S₃ . . . S_{z}} exchange; or any other manner that is capable of maintaining the integrity of key 12. An additional level of security can be realized the use of a public key 24 that can, but need not be public but rather is designated as public as it can exist in the public domain. Master keys 12m and public key 24 can be exchanged at a lesser frequency than session keys 12s {S₁, S₂, S₃ . . . S_{z}}, which can be exchanged each session.

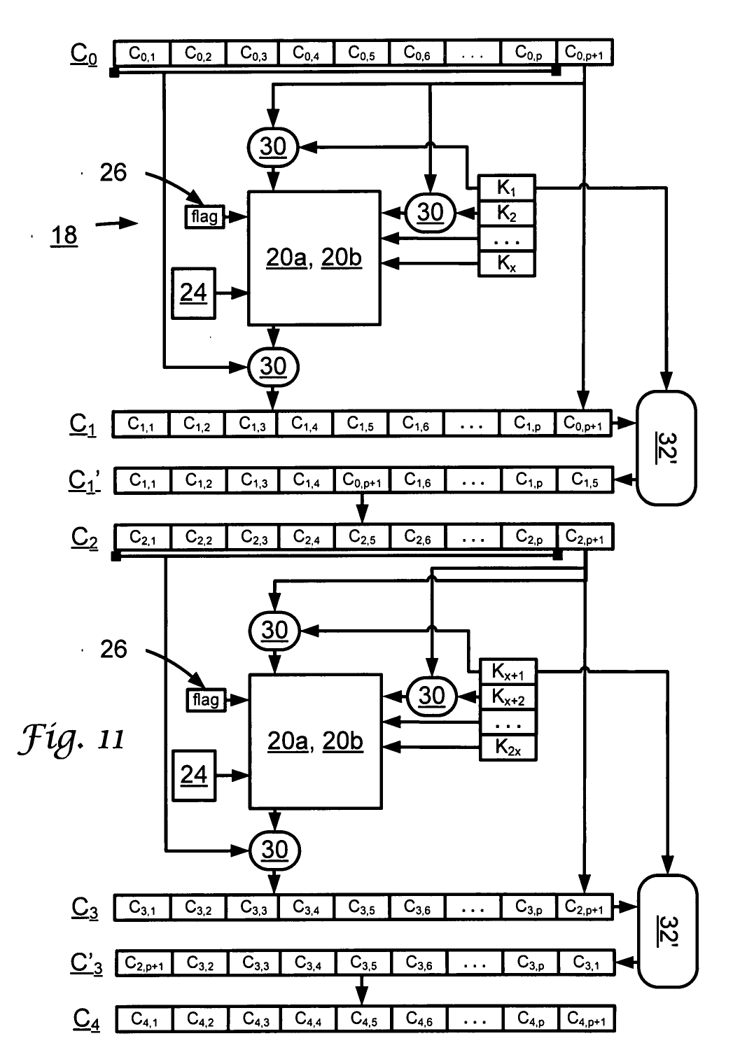

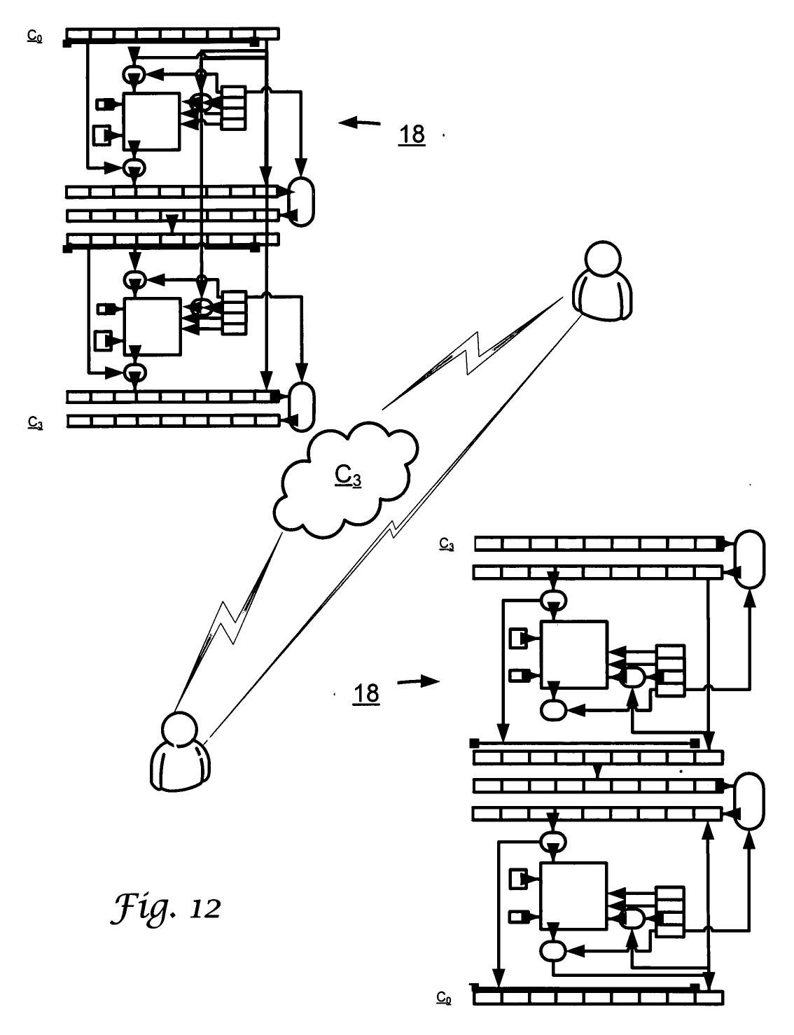

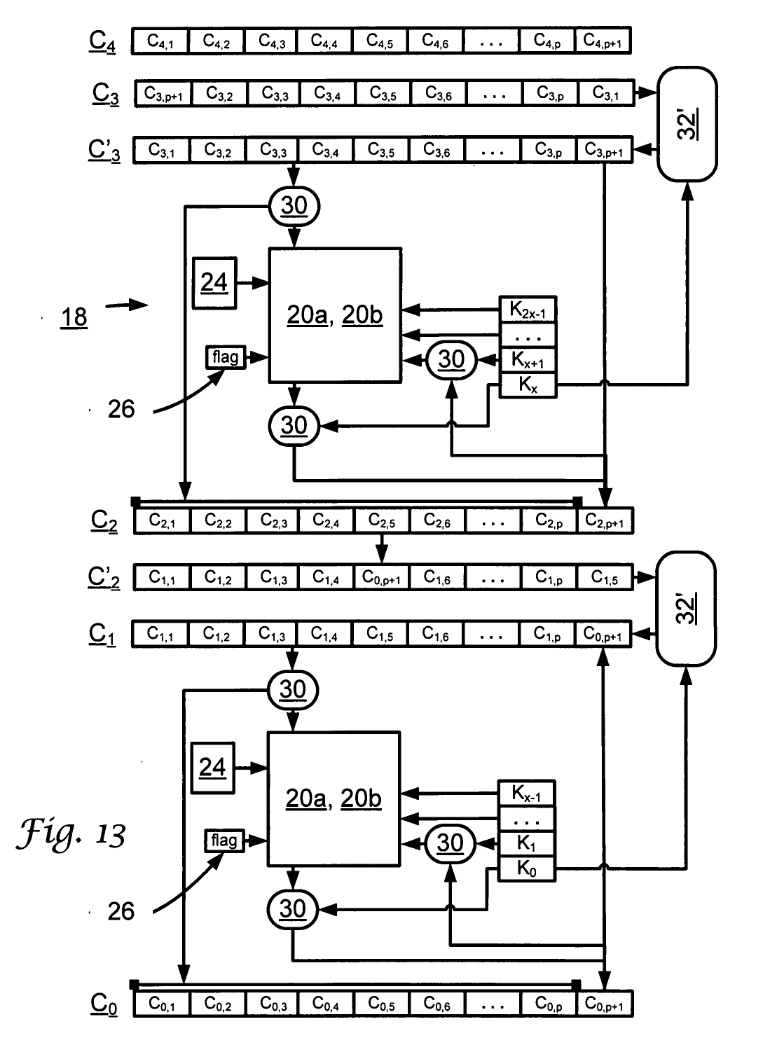

The graphical representation in FIG. 11 illustrates encryption of plain text C₀ {C_{0,1}, C_{0,2}, C_{0,3} . . . C_{0,p}, C_{0,p+1}} to intermediate cipher texts (e.g., C₁ {C_{1,1}, C_{1,2}, C_{1,3} . . . C_{1,p}, C_{0,p+1}}; C₂ {C_{2,1}, C_{2,2}, C_{2,3} . . . C_{2,p}, C_{2,p+1}}, . . . , C₃ {C_{3,1}, C_{3,2}, C_{3,3} . . . C_{3,p}, C_{2,p+1}}) and then to cipher text C₄ {C_{4,1}, C_{4,2}, C_{4,3} . . . C_{4,p}, C_{4,p+1}} using sub-key 22 {e.g., K₁, K₂, K₃ . . . K₂ₓ} and public key 24 when flag 26 sets security module 20a, 20b to encryption and encryptor/decryptor 18 mode. The graphical representation in FIG. 12 illustrates a cipher text C₄ {C_{4,1}, C_{4,2}, C_{4,3} . . . C_{4,p}, C_{4,p+1}} exchange in an information securing system 10. The graphical representation in FIG. 13 illustrates decryption of cipher text C₄ {C_{4,1}, C_{4,2}, C_{4,}3 . . . C_{4,p}, C_{4,p+1}} to intermediate cipher texts (e.g., C₃ {C_{3,1}, C_{3,2}, C_{3,3} . . . C_{3,p}, C_{3,p+1}} . . . C₂ {C_{2,1}, C_{2,2}, C_{2,3} . . . C_{2,p}, C_{2,p+1}} . . . C₁ {C_{1,1}, C_{1,2}, C_{1,3} . . . C_{1,p}, C_{0,p+1}} and then to plain text C₀ {C_{0,1}, C_{0,2}, C_{0,3} . . . C_{0,p}, C_{0,p+1}} using sub-key 22 {e.g., K₁, K₂, K₃ . . . K₂ₓ} and public key 24 when flag 26 sets security module 20a, 20b to decryption and encryptor/decryptor 18 mode.

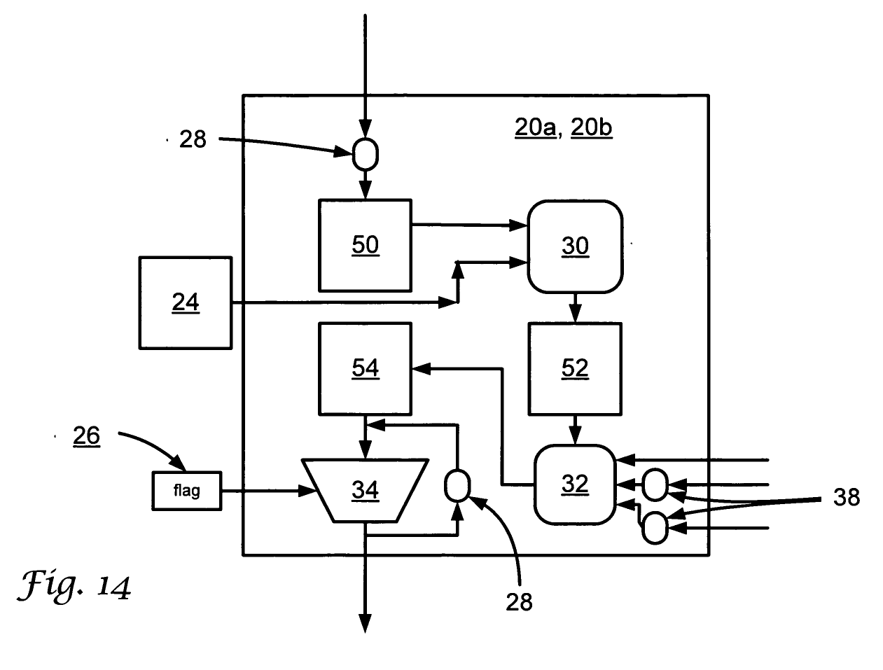

The graphical representation in FIG. 14 illustrates a security module 20a, 20b is a graphical representation of a generalized security module 20a, 20b according to an aspect of an embodiment of the present invention. Aspects of the scrambler 32 can be seen in FIG. 6 and FIG. 7. Aspects of the hashers can be seen in FIG. 8 and FIG. 9.

In combination, FIGS. 1 and 16 through 22 illustrate aspects of embodiments of an information securing system 10, a security module 20a, 20b, a method for securing information, and an algorithm for securing information. As noted, the state diagram of FIG. 1 illustrates in linkable arrangement an expander 28, a combiner 30, a scrambler 32, a hasher 34, and a randomizer 38.

An aspect of an information securing system 10 is to alter the plaintext to a cipher text by generating a large space of multiple sequences of pseudo random data from a portion (e.g., 32-bits or 64-bits) of the data (plaintext) to be encrypted and applying combinations of scrambled random data. In an aspect, a sub-key generator 14 can operate as a novel block cipher. Another aspect of an information securing system 10 is to design system 10 that provides a tradeoff between security and speed, flexibility, simplicity, scalability, conflict resolution capability, authentication capability, and suitability for a variety of security applications. By including a block cipher, such a system 10 can allow a wide range of block sizes for encryption with a very large key space. It makes the information securing system 10 flexible and provides easy customization for different applications while maintaining a high degree of security.

Randomizers 38 can include pseudo random number generators that can play a role in an information securing system 10 and make the system 10 unique. The pseudo random number generators can be traditional linear congruent generators (that are typically not recommended for cryptographic applications) or the modern cryptographically secure pseudo random number generators (PRNG), such as, for example, without limitation, Yarrow type generators or ISAAC type generators or ANSI X9.17 standard type generators, depending on the level of security desired. An alternative approach to using pseudo random number generators is also suggested in this application (see e.g., Tables 3A and 3B). Although linear congruent type generators are not suitable for cryptographic algorithms, due to the secure nature of the system 10, it is acceptable to use them as an alternative approach. Use of a linear congruent PRNG type generators, ISAAC type generators, ANSI type generators and the alternative generator of the present application have been found to be suitable.

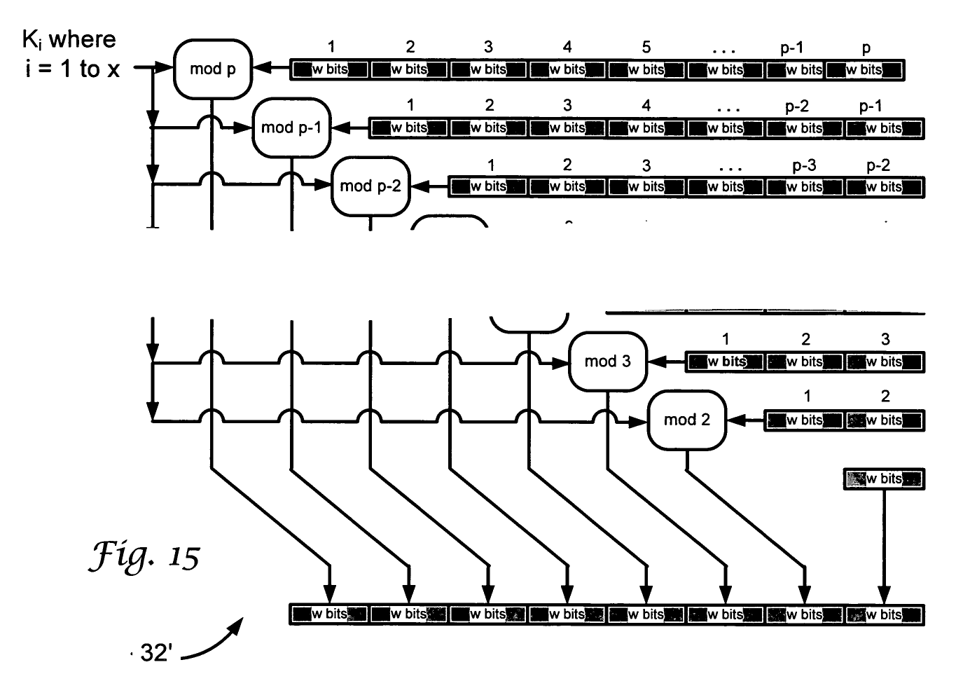

FIG. 15 depicts Scrambler 32′. The Scrambler 32′ takes a key Kᵢ and generates a pseudo random integer. This random integer is then divided by integer p and the remainder is used to extract a w-bit word as the first word to an intermediate cipher. Then another pseudo random integer is generated and this time it is divided by integer (p−1) to extract the w-bit word. This process is carried out as shown in FIG. 15 until all w-bit words are shuffled or permutated.

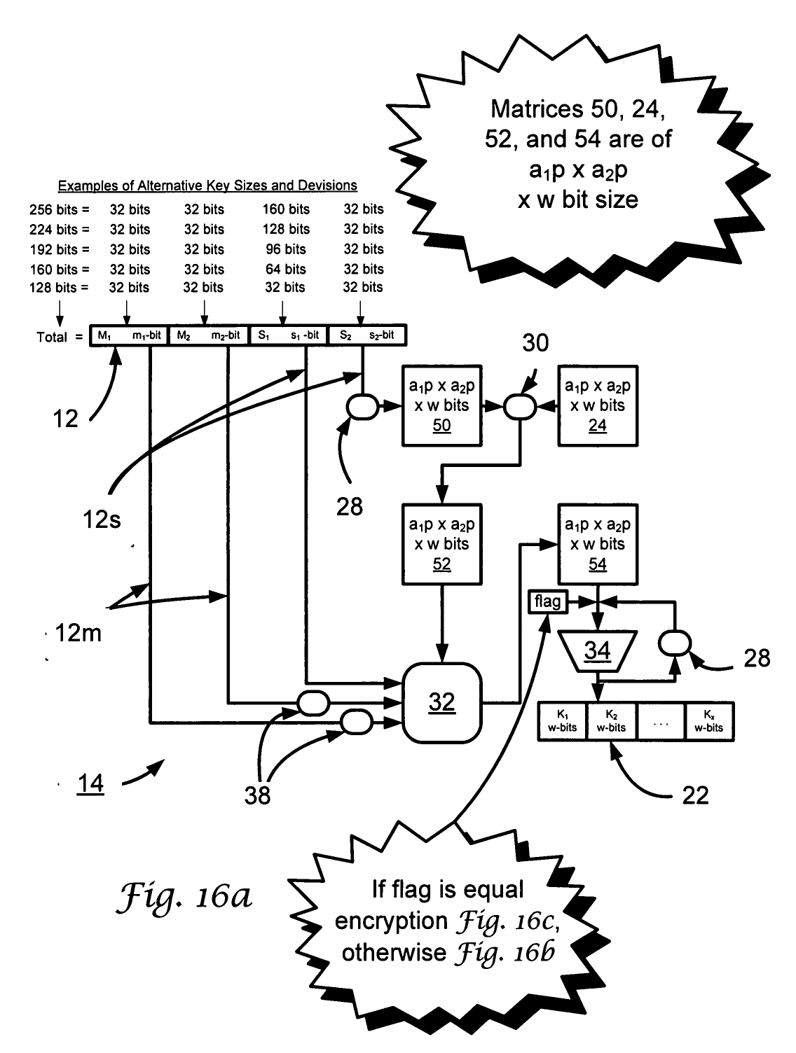

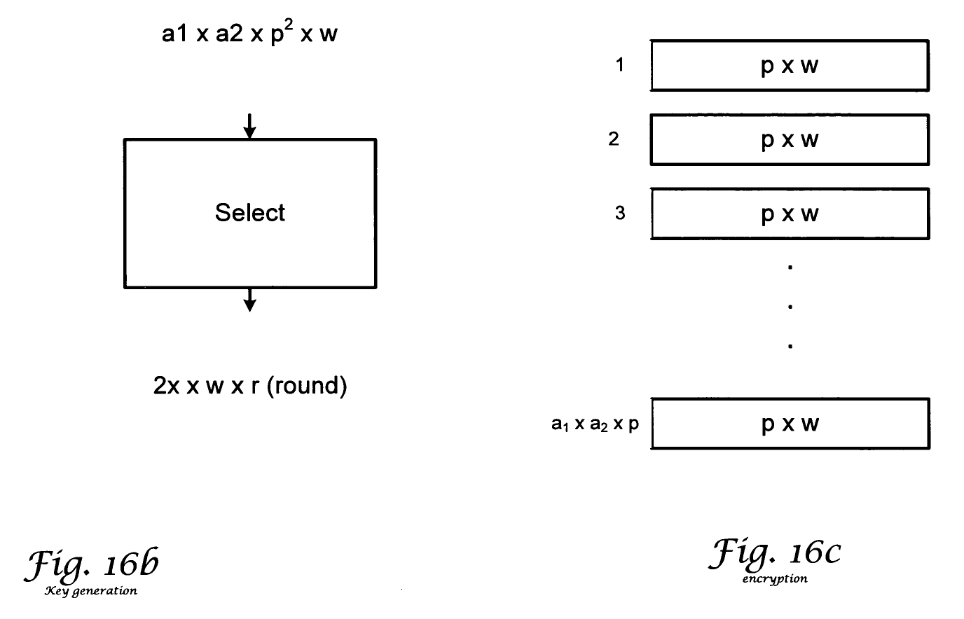

FIGS. 16 a, 16b and 16c depict a sub-key generator 14 as well as an encryptor/decryptor 18 according to aspects of an embodiment of the invention. In FIGS. 16a and 16b, a key 12 that is divided into 4 sections (e.g., if the key is 128-bits long, each portion might have 32-bits). A non exhaustive list of examples of alternative key sizes and divisions of key 12 is in Table 1 presented below.

TABLE 1
Example of Alternative Key Sizes for a Four Component Key

| Total Key Size | Master Key | | Session Key | |
|---|---|---|---|---|
| m₁ + | M₁ key size | M₂ key size | S₁ key size | S₂ key size |
| m₂ + s₁ + s₂ | m₁ bits | m₂ bits | s₁ bits | s₂ bits |
| 256 bits | 32 bits | 32 bits | 160 bits | 32 bits |
| 224 bits | 32 bits | 32 bits | 128 bits | 32 bits |
| 192 bits | 32 bits | 32 bits | 96 bits | 32 bits |
| 160 bits | 32 bits | 32 bits | 64 bits | 32 bits |
| 128 bits | 32 bits | 32 bits | 32 bits | 32 bits |

As noted above, one portion of these sections can be used as a master key 12m while another portion of these sections can be used as a session key 12s. Further, some or both of these portions can be used as seed values to an expander 28 and/or a randomizer 38 so as to generate a number of sequences of pseudo random numbers. Some or all of these sequences can be input into a scrambler 32, 32′, 32″ to generate a desired number of sub-keys 22. A hasher 34 can be used during a generation of sub-keys 22 to obtain variable length sub-keys 22.

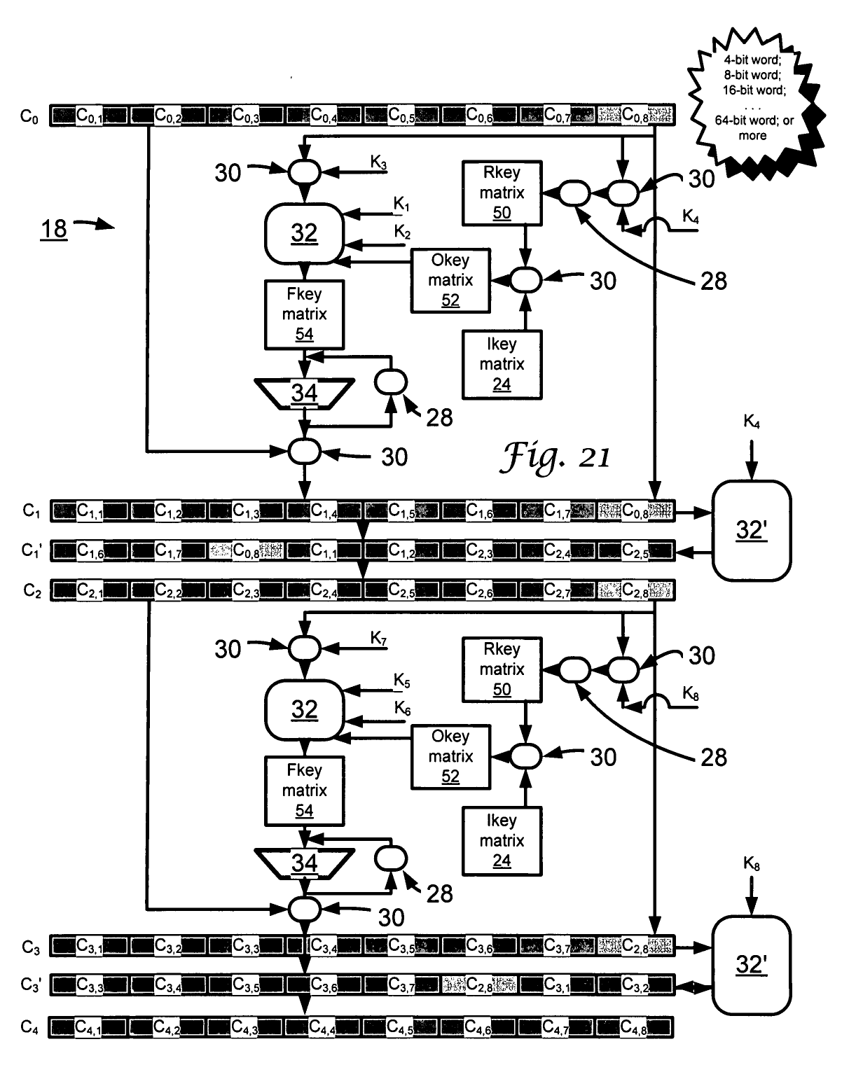

For the encryptor/decryptor mode (encryptor/decryptor 18), as can be seen in FIG. 21, an input data (plaintext) block can be divided into multiple (e.g., C₀ {C_{0,1}, C_{0,2}, C_{0,3} . . . C_{0,7}, C_{0,8}}) and/or unequal sub blocks (e.g., {C_{0,1}, C_{0,2}, C_{0,3} . . . C_{0,7}} and C_{0,8}). One of the sub blocks (e.g., C_{0,8}) may be used to generate a large space of pseudo random data, and this pseudo random data can be used to alter the larger sub block (e.g., {C_{0,1}, C_{0,2}, C_{0,3} . . . C_{0,7}}). After scrambling, the new block, which includes both encrypted (e.g., {C_{1,1}, C_{1,2}, C_{1,3} . . . C_{1,7}}) and non encrypted sub blocks (e.g., C_{0,8}), is then divided into multiple (e.g., C₂ {C_{2,1}, C_{2,}2, C_{2,3} . . . C_{2,7}, C_{2,8}}) and/or unequal sub blocks (e.g., {C_{2,1}, C_{2,2}, C_{2,3} . . . C_{2,7}} and C_{2,8}) again, and the same random encryption process may be carried out to ensure the previously unencrypted sub block is included, this time as a part of the larger sub block that is being encrypted.

The use of multiple sequences of pseudo random data and their key dependent combinations applied to a bit set that is in general larger than actual input data can make the attack of encrypted data harder. An attacker would need to try out all possible random combinations of the random data in order to attack the cipher. If the speed is not the issue and security is a major concern, a very large key can be used, which may be even greater than the traditional key size of 128 bits (e.g., 256, 512 . . . and even larger). This can make the brute force attack virtually impossible, and the use of random numbers to alter the original input data makes the cryptanalysis even harder. The cryptographic processes used in both the sub-key generator 14 and the encryptor/decryptor 18 can make both highly reliable, and this tactic can make an attack more difficult.

### Sub-Key Generator 14

In a information securing system 10, a sub-key generator 14 (see FIGS. 16a and 16b) can be used to create a set of sub-keys 22 that can be used in different rounds (repetition of the same process with different keys) in an associated encryptor/decryptor 18 (see FIG. 21). Sub-key generator 14 generates sub-keys 22 from a key 12 in which the original key (that can included a master key 12m and a session key 12s) can be repeatedly modified to generate desired number of sub-keys 22. This modification process can be, in general, carried out over a bit set of the same size as key 12. Thus the security of the sub-keys 22 can rest on the size of key 12 and the randomness that the sub-key generator 14 can create in the sub-keys 22.

A sub-key generator 14 can be capable of using a larger bit set than the original bit set of key 12 in the process of generating sub-keys 22. The sub-key generator 14 may be used in linkable arrangement with some or all of any one or more of an expander 28, a combiner 30, a scrambler 32, a hasher 34, and/or a randomizer 38. This allows the sub-key generator 14 to provide better security and significant randomness in the sub-keys 22.

FIGS. 16a and 16b present an overview of a sub-key generator 14. These figures show a master key 12m (including portions M₁ and M₂) and a session key 12s (including portions S₁ and S₂) sections of the key 12, public key matrix 24 (represented by public key 24), an expanded key matrix 50 (represented by expanded key matrix), combination matrix 52 (represented by combination matrix 52), scrambled matrix 54 (scrambled matrix 54) and sub-key matrix 22.

In this example, master key 12m has two sections, M₁ and M₂, of 32-bits each. Similarly, session key 12s has two sections, S₁ and S₂. The size of S₂ is 32-bits, and the size S₁ ranges from 32-bits to 160-bits by 32-bits increments. The matrices public key matrix 24, expanded key matrix 50, combination matrix 52 and scrambled matrix 54 in this example are two dimensional arrays typically (minimum) of 56×56 blocks of 32-bit integers. The cryptographic scrambler 32 and hasher 34 are capable of operating on a larger bit set than the size of the key 12 to provide higher security and better randomness. The master key 12m and public key matrix 24 can be a user dependent key and can be first exchanged at the beginning of a data exchange relationship; however, a new master key 12m and public key matrix 24 can be exchanged at any time if it is agreed to so do and/or the previous master key 12m or public key matrix 24 are compromised.

The session key 12s is also a key 12, and it is exchanged at the beginning of each session. The strength of the system 10 can be dependent on the content and the secure key management of the public key matrix 24. The elements of expanded key matrix 50 can be pseudo random integers that are generated using a 32-bit integer in session key 12s₂ as the seed to an expander 28 that in an embodiment can be a pseudo random number generator. The elements of combination matrix 52 can be created by a combiner 30, which in an aspect of an embodiment can be an XOR, using corresponding elements of the public key matrix 24 and expanded key matrix 50.

A scrambler 32 accepts random numbers generated by using master key 12m₁ (M₁) as the seed to an randomizer 38, random numbers generated by using master key 12m₂ (M₂) as the seed to an randomizer 38, session key 12s₁ (S₁) and combination matrix 52 and alters the bit sequence of combination matrix 52 by using a combination of one or more bit-shifters 40 and one or more permutator 42. Outputs of scrambler 32 include a scrambled matrix 54. A hasher 34 then can accept the scrambled matrix 54 and produces a variable length sub-keys 22 based on desired sub-key length for an associated encryptor/decryptor 18. The sub-key length size and portions can be customized as desired.

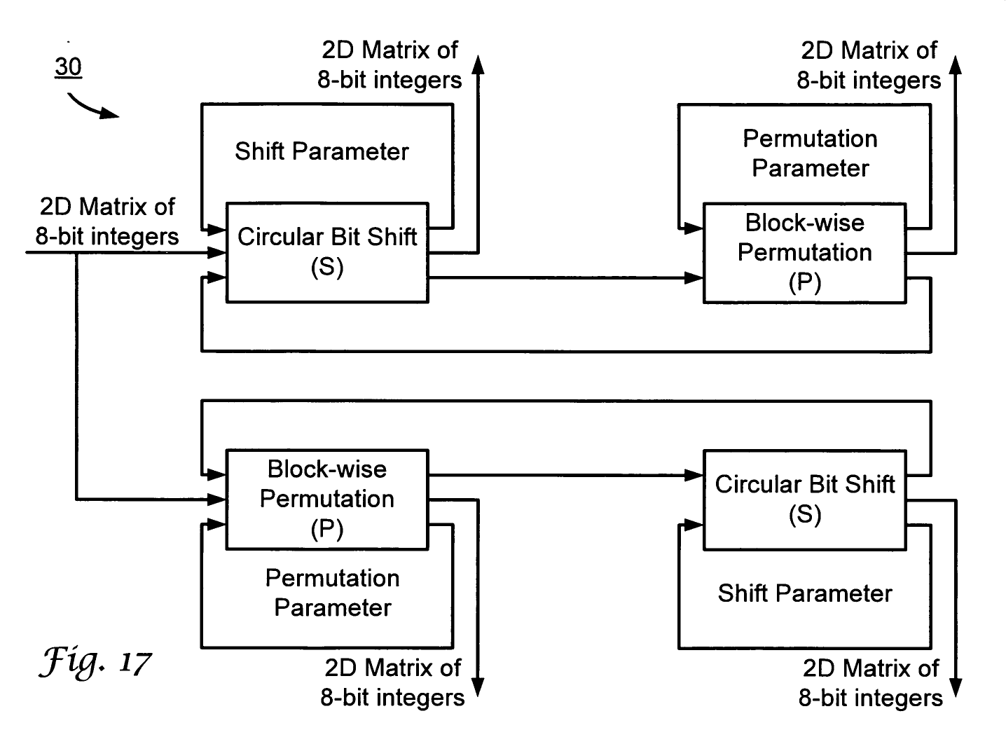

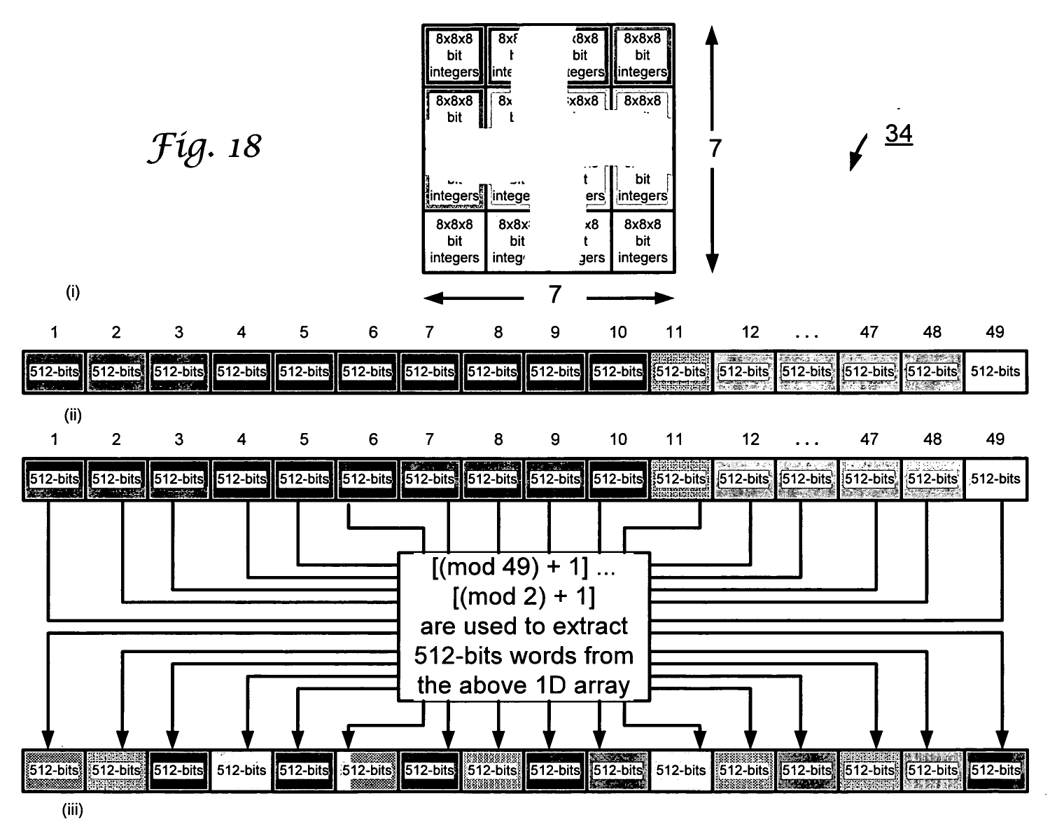

Examples of steps of operations of a scrambler 32 and a hasher 34 are presented in Table 2A and FIGS. 17 and 18 respectively. As noted, a scrambler 32 scrambles the combination matrix 52 by using a combination of one or more bit-shifters 40 and one or more permutators 42, and a hasher 34 hatchets the output.

In Table 2A, there are six columns. The first column represents a sequence of pseudo random numbers generated using the m₁-bit integer of master key 12m₁ (M₁), the second column represents a sequence of pseudo random numbers generated using the m₂ bit integer master key 12m₂ (M₂), the third column represents the s₁ bits in the session key 12s₁ (however, as stated before the size of key 12s₁ (S₁) can take any number of bits, such as, e.g., 8 bits up through 256 bits and more), the fourth column represents the seed value selected for the permutator 42, the fifth column represents the shift value selected for bit-shifters 40, and the sixth column shows the corresponding operation applied on the 2D combination matrix 52 matrix.

The two sequences of pseudo random numbers generated using a master key 12m₁ (M₁), denoted by a₀, a₁, . . . a₃₁ and a master key 12m₂ (M₂), denoted by b₁, b₂, . . . b₃₁. The size of the session key 12s₁ determines the number of pseudo random numbers generated in the sequences. For example, if the session key 12s₁ has 32 bits, then two sequences of 32 pseudo random integers can be generated. Similarly, if it has 64 bits, then two sets of 64 pseudo random integers can be generated. This approach makes the length of these sequences arbitrary and provides flexibility for choosing desired lengths. It should be noted that the sizes of the master key 12m₁ (M₁), the master key 12m₂ (M₂), and the session key 12s₁ can be more or less than 32-bit. For example, if the computer processor has an ability to process 64-bit integers, then the master key 12m₁ (M₁), the master key 12m₂ (M₂), and the session key 12s₁ can be 64-bit. Thus, the key 12 can be easily customized based on a user's desire and ability to process using the available hardware capability.

Also, randomizer 38 can be customized. Despite not being recommended for cryptographic applications in general, randomizer 38 can be a traditional linear congruent generator. Alternatively, randomizer 38 can be any of the known modern cryptographically secure pseudo random number generators such as, for example, any one of an ANSI X9.17, a Yarrow algorithm, or an ISAAC algorithm, depending on the level of security desired for an applications.

Table 3A presents an alternative randomizer 38 and/or expander 28. Table 3A shows two columns. The first column presents the algorithm in a pseudo code fashion, and the second column presents a sample of one of its sequence of output. This alternative randomizer 38 and/or expander 28 accepts an arbitrary size bit sequence and produces a much larger bit set to generate a set of pseudo random integers with variable size.

As demonstrated by the pseudo code of alternative randomizer 38 and/or expander 28 in Table 3B, a 32-bit integer in a bit set format is accepted, and for each bit in the set, it generates its corresponding decimal number chosen between 0 and 9 inclusive. A larger integer using these decimal numbers as digits is then formed, and this large number is converted to a bit set, which is much larger than 32-bits. The same process is conducted on the new bit sequence to generate larger bit set, and this process can be repeated until a desired number of bits are obtained. An example is presented in the second column of Table 3B. This alternative randomizer 38 and/or expander 28 can be memory intensive as well as processor demanding, and thus, it can make system 10 more robust to known attacks.

TABLE 2A
Security Function Chart

| | | | | Circular | |
|---|---|---|---|---|---|
| Private Key | | | | Shift | |
| | | Session | Permutation | If session | |
| | | Key | If session key | key bit (sᵢ) | |
| Master Key | | S₁: | bit (sᵢ) is 1 | is 0 choose | |
| M₁: | M₂: | s₁-bits | choose this | this | Scrambling of combination |
| m₁-bits | m₂-bits | (example) | operation | operation | matrix 52 |
| a₀ | b₀ | (1) s₀ | c₀ = | | Permute using seed c₀ |
| | | | (a₀ + b₀)mod(2^{ω}) | | |
| a₁ | b₁ | (0) s₁ | | c₁ = | Shift c₁ bits |
| | | | | (a₁ + b₁)mod(2^{ω}) | |
| a₂ | b₂ | (1) s₂ | c₂ = | | Permute using seed c₂ |
| | | | (a₂ + b₂)mod(2^{ω}) | | |
| a₃ | b₃ | (1) s₃ | c₃ = | | Permute using seed c₃ |
| | | | (a₃ + b₃)mod(2^{ω}) | | |
| a₄ | b₄ | (0) s₄ | | c₄ = | Shift c₄ bits |
| | | | | (a₄ + b₄)mod(2^{ω}) | |
| a₅ | b₅ | (1) s₅ | c₅ = | | Permute using seed c₅ |
| | | | (a₅ + b₅)mod(2^{ω}) | | |
| a₆ | b₆ | (0) s₆ | | c₆ = | Shift c₆ bits |
| | | | | (a₆ + b₆)mod(2^{ω}) | |
| . | . | . | . | . | . |
| . | . | . | . | . | . |
| . | . | . | . | . | . |

TABLE 2B
Security Function Chart

| Private Key | | | | | |
|---|---|---|---|---|---|
| | | Session | Permutation | Circular Shift | |
| | | Key | If session key | If session key | |
| Master Key | | S₁: | bit (sᵢ) is 1 | bit (sᵢ) is 0 | |
| M₁: | M₂: | 32-bits | choose this | choose this | Scrambling of combination |
| 32-bits | 32-bits | (example) | operation | operation | matrix 52 |
| a₀ | b₀ | (1) s₀ | c₀ = | | Permute using seed c₀ |
| | | | (a₀ + b₀)mod(2³²) | | |
| a₁ | b₁ | (0) s₁ | | c₁ = | Shift c₁ bits |
| | | | | (a₁ + b₁)mod(2³²) | |
| a₂ | b₂ | (1) s₂ | c₂ = | | Permute using seed c₂ |
| | | | (a₂ + b₂)mod(2³²) | | |
| a₃ | b₃ | (1) s₃ | c₃ = | | Permute using seed c₃ |
| | | | (a₃ + b₃)mod(2³²) | | |
| a₄ | b₄ | (0) s₄ | | c₄ = | Shift c₄ bits |
| | | | | (a₄ + b₄)mod(2³²) | |
| a₅ | b₅ | (1) s₅ | c₅ = | | Permute using seed c₅ |
| | | | (a₅ + b₅)mod(2³²) | | |
| a₆ | b₆ | (0) s₆ | | c₆ = | Shift c₆ bits |
| | | | | (a₆ + b₆)mod(2³²) | |
| . | . | . | . | . | . |
| . | . | . | . | . | . |
| . | . | . | . | . | . |

TABLE 3A
Alternative randomizer 38 and/or expander 28

| | |
|---|---|
| b = b₀ b₁ b₂ ............... b_{ν-1} | b = 01101111 (only 8-bit input |
| for i = 0 ... ν−1 | is shown as an example) |
| if bi = 0 | d0 = 5 |
| then | d1 = 3 |
| dᵢ = bᵢ + 2*b_{(i+1)%ν} + 4*b_{(i+2)%ν} + 8*b_{(i+3)%ν} + 16*b_{(i+4)%ν} | d2 = 0 |
| else | d3 = 2 |
| dᵢ = bi + 2*b_{(i+2)%ν} + 4*b_{(i+4)%ν} + 8*b_{(i+5)%ν} | d4 = 4 |
| end if | d5 = 5 |
| dᵢ = (b + dᵢ)%9 | d6 = 0 |
| 1-bit circular bit shift of b | d7 = 1 |
| end for | d = 5 + 10*3 + 100*0 + 1000*2 + |
| d = d₀ + 10*d₁ + 10²*d₂ +....+ 10^{ν-1}*d_{ν-1} | 10000*4 + |
| d = b₀ b₁ b₂ ............... bₙ | 100000*5 + 1000000*0 + |
| for i = 0 .. n−1 | 10000000*1 |
| if bᵢ = 0 | d = |
| then | 01101101111010011000000001010000 |
| dᵢ = bᵢ + 2*b_{(i+1)%ν} + 4*b_{(i+2)%ν} + 8*b_{(i+3)%ν} + | 80 |
| 16*b_{(i+4)%ν} | 128 |
| else | 233 |
| dᵢ = bi + 2*b_{(i+2)%ν} + 4*b_{(i+4)%ν} + 8*b_{(i+5)%ν} | 109 |
| end if | |
| dᵢ = (b + dᵢ)%9 | |
| 1-bit circular bit shift of d | |
| end for | |
| d = d₀ + 10*d₁ + 10²*d₂ +....+ 10ⁿ⁻¹*d_{n -1} | |
| d = b₀ b₁ b₂ ............... bₙ₊ₘ | |
| continue the process until you get a desired number of | |
| bits | |

TABLE 3B
Alternative randomizer 38 and/or expander 28

| | |
|---|---|
| b = b₀ b₁ b₂ ............... b₃₁ | b = 01101111 (only 8-bit input |
| for i = 0 ... 31 | is shown as an example) |
| if bi = 0 | d0 = 5 |
| then | d1 = 3 |
| dᵢ = bᵢ + 2*b_{(i+1)%32} + 4*b_{(i+2)%32} + 8*b_{(i+3)%32} + 16*b_{(i+4)%32} | d2 = 0 |
| else | d3 = 2 |
| dᵢ = bi + 2*b_{(i+2)%32} + 4*b_{(i+4)%32} + 8*b_{(i+5)%32} | d4 = 4 |
| end if | d5 = 5 |
| dᵢ = (b + dᵢ)%9 | d6 = 0 |
| 1-bit circular bit shift of b | d7 = 1 |
| end for | d = 5 + 10*3 + 100*0 + 1000*2 + |
| d = d₀ + 10*d₁ + 10²*d₂ +....+ 10³¹*d₃₁ | 10000*4 + |
| d = b₀ b₁ b₂ ............... bₙ | 100000*5 + 1000000*0 + |
| for i = 0 .. n−1 | 10000000*1 |
| if bᵢ = 0 | d = |
| then | 01101101111010011000000001010000 |
| dᵢ = bᵢ + 2*b₍ᵢ₊₁₎%₃₂ + 4*b₍ᵢ₊₂₎%₃₂ + 8*b_{(i+3)%32} | 80 |
| +16*b_{(i+4)%32} | 128 |
| else | 233 |
| dᵢ = bi + 2*b_{(i+2)%32} + 4*b_{(i+4)%32} + 8*b_{(i+5)%32} | 109 |
| end if | |
| dᵢ = (b + dᵢ)%9 | |
| 1-bit circular bit shift of d | |
| end for | |
| d = d₀ + 10*d₁ + 10²*d₂ +....+ 10ⁿ⁻¹*dₙ₋₁ | |
| d = b₀ b₁ b₂ ............... bn+m | |
| continue the process until you get a desired number of | |
| bits | |

Table 2B assumes 32-bits for the session key 12s₁. These bits are denoted by s₀, s₁, . . . , s₃₁. For explanation purposes, assume the first 7 bits to be 011010. The third column in Table 2B presents this information. The first bit is 1, thus the permutators 42 is chosen and the corresponding pseudo random integer a₀ and b₀ are added using modular 2³² to get another set of random integers of 32-bit integers for blockwise permutation. The second bit is 0, thus the bit-shifters 40 is chosen and the pseudo random integer a1 and b1 are added using modular 2³² to get the size for circular bit shift operation. This pattern of choosing between permutator 42 and bit shifter 40 continues until all of the bits of session key 12s₁ are used. Once the appropriate operation and the corresponding seed value or shift parameter is selected, the scrambling process on the 2D matrix will take place. The sequence choosing between permutator 42 and bit shifter 40 within scrambler 32 is illustrated in FIG. 17.

FIG. 17 illustrates the possible sequences of choosing between permutator 42 and bit shifter 40 from the steps explained in Table 1. It forms a binary tree of cryptographic operations on the 2D matrix which is an input to the scrambler 32. For example, in two steps the possible sequence of operations are PP or PS or SP or SS, where P stands for blockwise permutation and S stands for circular bit shift operation.

That is, in two steps, there are four possible sequences of cryptographic operations. Similarly, in three steps, there are eight possible sequences of cryptographic operations. Therefore, if there are 32-bits in the session key 12s₁, there are 32 steps which give us 2³² possible sequences of cryptographic operations on the scrambling process of 2D input matrix and depending on the size of the 2D matrix number of P operations and S operation will be applied in the process. This makes the algorithm highly secure and makes the brute-force attack and cryptanalysis significantly harder.

FIG. 18 illustrates one method for carrying out a blockwise permutation operation on the 2D input matrix. In this method, a static table to hold a permutation matrix is not maintained. Instead, the permutation can be carried out on the fly. FIG. 18 illustrates this operation using a smaller number of blocks. For this example, a 7×7 blocks of 8×8 8-bit integers for 2D input matrix were chosen as shown in FIG. 18.

The 2D matrix is converted into a 1D array of 49 elements with each element having 512-bits as shown in FIG. 18. These elements are labeled from 1 to 49 in order, taken from the 2D matrix block by block from left to right and top to bottom. This 1D array and a sequence of pseudo random numbers are the input to a module presented in FIG. 18 that carries out the permutation operation. Since the 1D array has 49 elements, “[(mod 49)+1]”, “[(mod 48)+1]”, . . . , “[(mod 2)+1]” operations can be used in this order to permute the blocks.

At the start, the first pseudo random number can be divided using “[(mod 49)+1]”, operation, and the 512-bit element in that position in the 49 elements array is selected and moved to the first element of the output array. The input array is now reduced to 48 elements and “[(mod 48)+1]”, is applied to the second pseudo random number. Now the 512-bit element sitting at that position in the 48 elements array is selected and moved to the second element of the output array. The process is continued until all the elements of the input array are moved to the output array. This gives an output array which has a random permutation of the elements in the input array. The same process can be used as inverse process to obtain the input array.

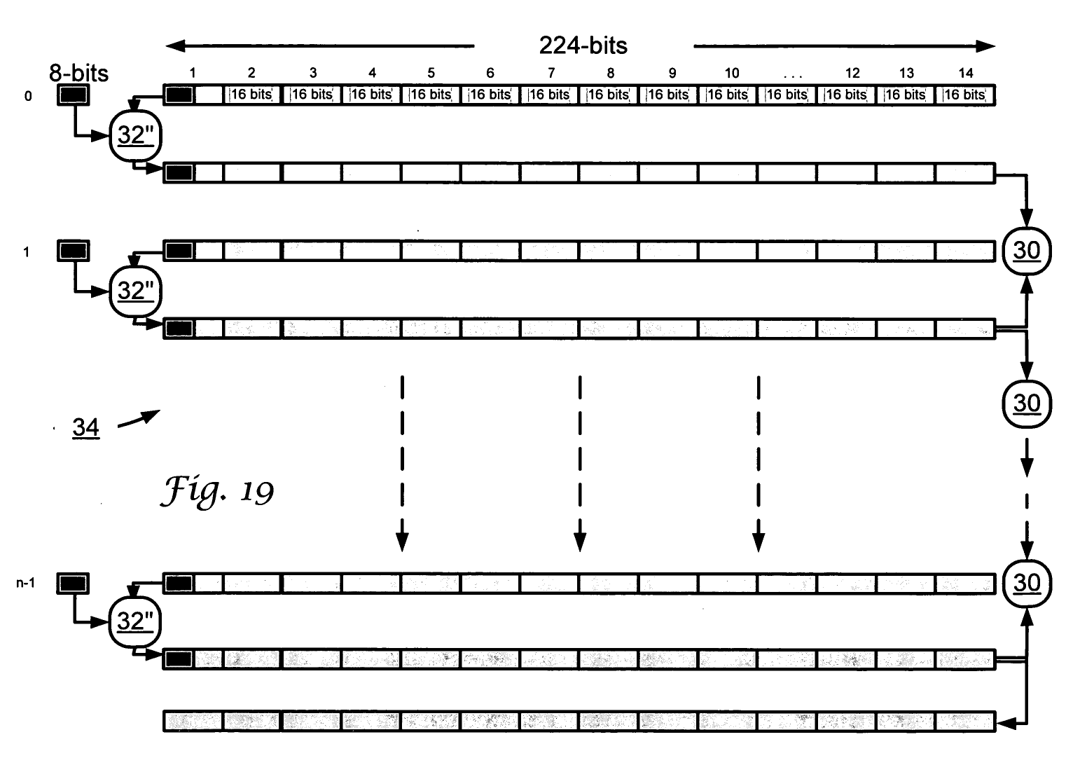

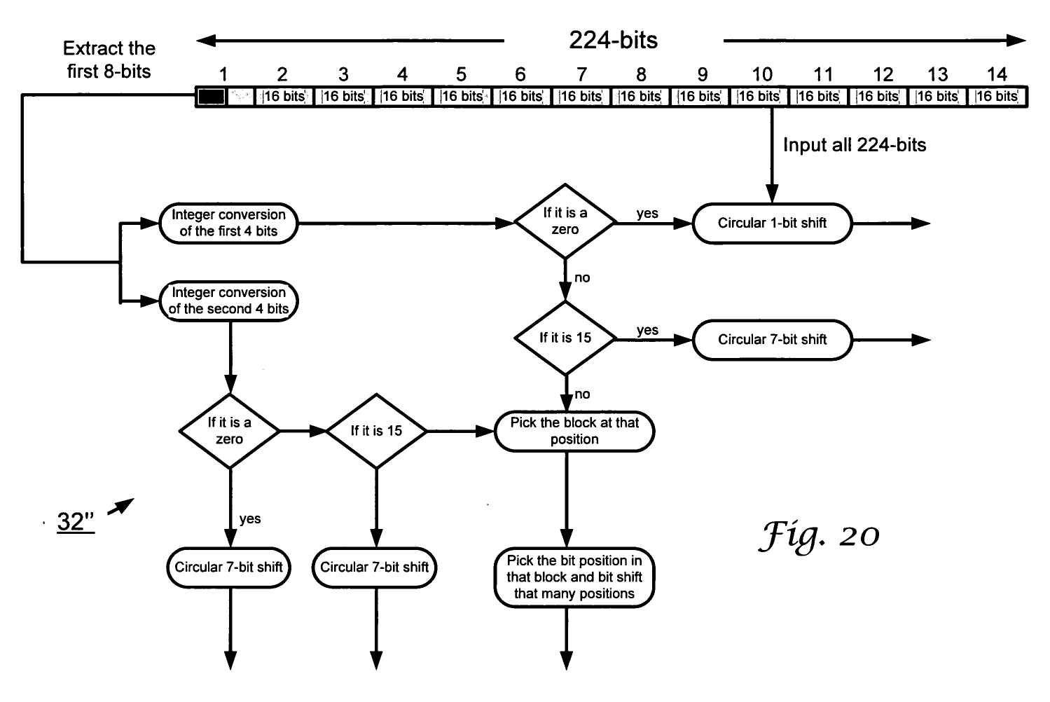

FIG. 19 and FIG. 20 present the processes of the hasher 34. A simple hasher 34 can be used to enhance the flexibility of the sub-key generator 14. However, if security is of a greater concern, not the computational complexity, other types of more or highly secure hashers 34 can be used. Because the strength of scrambler 32 is very high and the bit set is significantly large, a simple hasher 34 can be sufficient to maintain an appropriate tradeoff between security and speed.

For illustrative purposes, 448 blocks of 224 bits are input into hasher 34. This would generate sixteen blocks of 224-bits for sub-key generator 14 and one block of 224-bits for encryptor/decryptor 18. In this manner, for encryptor/decryptor 18 all of the 448 blocks of 224-bit block will go through the scrambler 32″, and the results will be input into combiner 30 (e.g., XOR added) to get a final 224-bit block. However, for encryptor/decryptor 18 a range of block sizes 128-bit, 160-bit, 192-bit, 224-bit, and 256-bit can be used. Thus, the hasher 34 would be able to generate 224-bit, 192-bit, 160-bit, 128-bit, and 96-bits. To achieve this, the more and/or most significant 192, 160, 128, and 96 bits of 224-bit block in these cases are used.

For sub-key generator 14, 448 blocks of 224-bits can be divided into 16 sets of 23 blocks of 224-bits, and each set can go through the scrambler 32″ and generate 16 224-bit blocks.

As shown in FIG. 19, the 224-bits in each row are divided into 14 16-bit blocks, and the first 8-bits then can be used to scramble the entire 224-bits. The first 4-bits can be used to pick a block number, and the next 4-bits can be used to pick a bit position in that block. The entire 224-bits can then be circularly bit shifted with respect to that bit position. The process of this bit shift is carried out using a scrambler 32″ as presented in FIG. 20. This process can be applied to all of the 224 bit entries in the rows and then input into combiner 30 (e.g., XOR added) column (bit) by column (bit) to obtain a new 224-bit set.

As mentioned, the process of this bit shift is carried out using a scrambler 32″ as presented in FIG. 20. It is explained using the flow chart. It scrambles the entire input bit set blockwise using 224-bit block size to generate a hash code of 224-bits. The non-reversible nature of scrambler 32″ creates a higher security. The choice of 224-bits for the explanation presented here is based on the size of the hash code compatible with the encryptor/decryptor 18. However, one could easily customize this size for different applications.

### Encryptor/Decryptor 18

In an information securing system 10, an encryptor/decryptor 18 encrypts a message using blockwise cryptographic operations. Throughout the encryption process, it scrambles the bits in the block over a bit set which is the same size as the original block. Thus, the security of an encryptor/decryptor 18 rests on its original block size. In traditional encryption, sub-keys are generated by an associated key generation algorithm that is in general different from the encryption algorithm. Typically the encryption algorithms do not use random numbers and thus the strength of the security restricted to the randomness generated on the cipher by the algorithms.

Some distinctions of an encryptor/decryptor 18 according to the present invention include:
(i) an availability of a wide range of block sizes;
(ii) a use of unequal sub block size;
(iii) a use of cryptographic operations on a significantly larger bit set size than the actual block of bits;
(iv) a use of random numbers, bit properties and a hasher 34; and
(v) a use of the same security module cryptographic functions in both a sub-key generator 14 and an encryptor/decryptor 18.
   These distinctions make the system 10 and allow it to provide better security and significant randomness in a cipher than currently available DES and AES type encryption standards.

FIG. 21 presents an encryptor/decryptor 18 according to an aspect of an embodiment of the present invention. It shows the input parameters (such as sub-keys 22 {e.g., K₁, K₂, K₃ . . . K₈} and plaintext C₀), operators (e.g., expander 28, combiner 30, scrambler 32, hasher 34 . . . etc.), output parameters (such as intermediate ciphers and round ciphers), and two stages of a first round of operations. The input parameters include the sub-keys 22 {e.g., K₁, K₂, K₃ . . . K₈} which are generated by the sub-key generator 14 according to another aspect of an embodiment of the present invention, a user supplied public key 24, a combination matrix 52, and the random key expanded key matrix 50 which is generated using K₄ and K₈ sub-keys 22. Intermediate ciphers are denoted by scrambled matrix 54 and intermediate ciphers C₁, C₁′, C₂, C₃ and C₃′. A final cipher to this first round is denoted by C₄.

A system 10 according to an aspect of an embodiment of the present invention, in contrast to DES and AES, supports a wider range of block sizes, 128-bits, 160-bits, 192-bits, 224-bits, and 256-bits for the plaintext, C₀. However, the flexible nature of the system 10 allows one to customize the system 10 to other block sizes. The plaintext, C₀, is the text that is encrypted using the encryptor/decryptor 18. The encryptor/decryptor 18 has been explained in this example as using a 256-bits block size. However, those skilled in the art will appreciate that the encryptor/decryptor 18 is capable of using other block sizes. Thus the plaintext, C₀, shown in FIG. 21, is divided into 32-bits words, and there are eight 32-bits blocks in the plaintext, C₀.

A plaintext, C₀, of 256-bits can be divided into eight equal 32 bit sub blocks (C_{0,1} through C_{0,8}) that in turn can be grouped as two unequal sub blocks of 224-bits (32-bit blocks C₀, through C_{0,7}) and 32-bits (32-bit block C_{0,8}). These grouped sub-blocks are denoted by L (left) and R (right) respectively, and the L is shaded in FIG. 21. Alternatively for high security, a plaintext, C₀, can be divided into four equal 64 bit sub blocks (C_{0,1} through C_{0,4}) that in turn can be grouped as two unequal sub blocks of 192-bits (64-bit blocks C_{0,1} through C_{0,3}) and 64-bits (64-bit block C_{0,4}). Such alternatives can be run using hardware/software that is capable of generating pseudo random numbers of 8-bits from a 64-bit seed value. Table 4 and Table 5 provide a list of block sizes for left grouped sub blocks and right sub block.

TABLE 4
Example

| | Left (L) | Right (R) |
|---|---|---|
| Block size | Grouped sub-blocks | Sub-block |
| 128 | 96 | 32 |
| 160 | 128 | 32 |
| 192 | 160 | 32 |
| 224 | 192 | 32 |
| 256 | 224 | 32 |

TABLE 5
Example

| | Left (L) | Right (R) |
|---|---|---|
| Block size | Grouped sub-blocks | Sub-block |
| 128 | 64 | 64 |
| 160 | 96 | 64 |
| 192 | 128 | 64 |
| 224 | 160 | 64 |
| 256 | 192 | 64 |

The operators are denoted by expander 28, combiner 30, scrambler 32, hasher 34 and scrambler 32′. The operators, expander 28, combiner 30, scrambler 32, and hasher 34 can be the same ones that were used in the associated sub-key generator 14. Scrambler 32′ carries out 32-bit blockwise permutations on the intermediate ciphers C₁ and C₃. Scrambler 32 accepts four parameters (three 32-bit sub-keys 22 that are generated from the associated sub-key generator 14 and one combination matrix 52 that is generated from the fourth 32-bits sub-key and the user supplied public key 24).

The encryptor/decryptor 18 depicted in FIG. 21 is based on 224-bits grouped sub block [left (L)] and 32-bits sub block [right (R)]. However, the sub block sizes shown in Table 2B and Table 3B can be used in the same manner. Encryptor/decryptor 18 encrypts the 224-bits left grouped sub block using the 32-bits in the right sub block. The choice of the right sub block size affects the size of the sub-keys 22 {e.g., K₁, K₂, K₃ . . . K₂ₓ} to be used. As mentioned earlier, the encryptor/decryptor 18 uses the scrambler 32 and hasher 34 used in the sub-key generator 14. In addition, it uses an additional or alternative scrambler 32′.

Encryptor/decryptor 18 repeatedly uses a security module 20a, 20b as used in the sub-key generator 14. One of the inputs to this encryptor/decryptor 18 is the sub-keys 22 that are generated from an original supplied key 12 of 128-bit key using the sub-key generator 14. The operation of the encryptor/decryptor 18 is now made while referring to FIG. 21.

Following the definition provided for the deterministic random numbers in the FIPS1402 document that states that “Random Number Generators (RNG) is used for cryptographic applications typically produces a sequence of zeros and ones that can be combined to sub sequences or blocks of random numbers”. It also states that a “deterministic RNG consists of an algorithm that produces a sequence of bits form an initial value called a seed.”

By now the reader should be familiar with the notations used in the sub-key generator 14, and the rest of the document uses these notations. In the encryptor/decryptor 18, the combination matrix 52 is generated using the expanded key matrix, which is generated from the 32-bit sub-key 22 k₃ using expander 28, and the public key 24, which is supplied by the user. (This key can be exchanged one time at the beginning of their agreement.) The 32-bit long sub-key k₃ is used as the session key 12ₛ S₂ in sub-key generator 14. This integer acts as the seed value for expander 28 that generates a sequence of deterministic random integers for expanded key matrix 50.

The sub-keys 22 {e.g., K₁, K₂, K₃ . . . K₂ₓ} and matrix 50 are used as inputs into scrambler 32 in the same manner that M₁ and S₁ are used as inputs into scrambler 32 in the sub-key generator 14. In scrambler 32, the S₁ determines the number of cryptographic operations that are to be carried out on the combination matrix 52. Therefore, the size of the right block can play a major role in the level of security of the cipher and it can support the easy customization of the algorithm.

Scrambler 32 generates a scrambled matrix 54 and then the hasher 34 generates cryptographically secure sub-key matrix 22 of the same size as left sub block (in this case 224-bits). The sub-key matrix 22 will be XOR with the 224-bit left block to generate the intermediate cipher C₁. The intermediate cipher C₁ and the sub-key k₃ will go through the scrambler 32′. The scrambler 32′ carries out 32-bit word blockwise permutation on the intermediate cipher C₁ using k₃ as the seed value. The new cipher C₂ goes through the same process to generate a new cipher C₃ and C₃ together with sub-key k₇ will go through the scrambler 32′ to generate the round cipher C4.

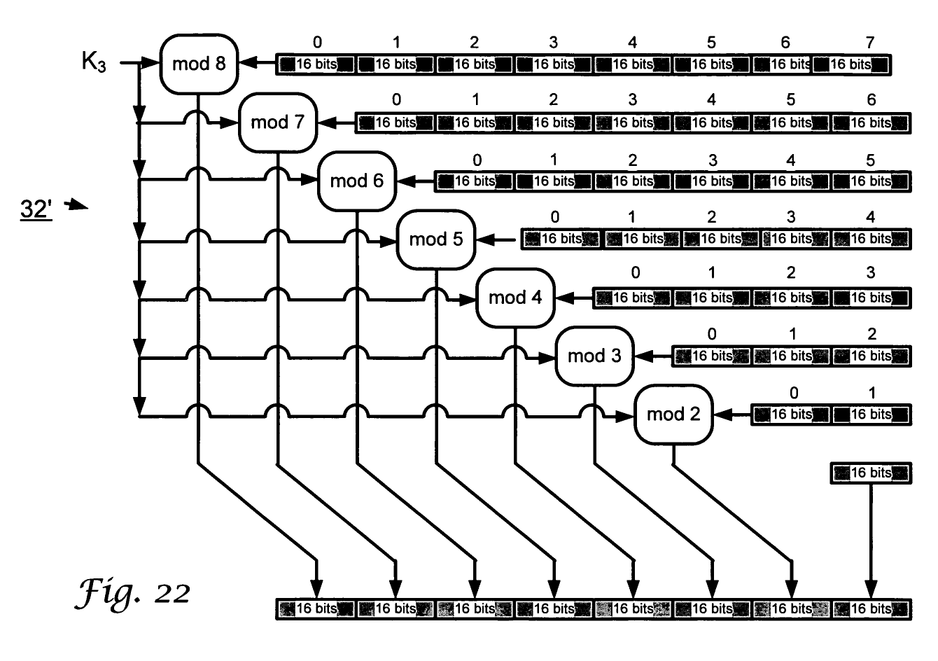

The scrambler 32 and the hasher 34 of the encryptor/decryptor 18 are substantially the same as the sub-key generator 14. The scrambler 32′ is presented in FIG. 22. This takes a key and generates a pseudo random integer. This random integer is divided by 8, and the remainder is used to extract the 8-bits word as the first 8-bit word to the intermediate cipher. Another pseudo random integer will then be generated, and this time, it is divided by 7 to extract the 8-bit word. This process will be carried out as shown in FIG. 22 until all 8-bits words are shuffled (permutated).

Certain modifications and improvements will occur to those skilled in the art upon a reading of the foregoing description. It should be understood that all such modifications and improvements have been deleted herein for the sake of conciseness and readability but are properly within the scope of the following claims.

We claim:

1. A system for securing information comprising:
(a) a key;
(b) a sub-key generator comprising a first security module wherein at least a portion of the key is an input to the sub-key generator and a sub-key is an output; and
(c) an encryptor/decryptor comprising a second security module wherein at least a portion of the sub-key is an input to the encryptor/decryptor.

2. A system for securing information according to claim 1, further comprising a public key.

3. A system for securing information according to claim 2, wherein the public key comprises a fingerprint.

4. A system for securing information according to claim 3, wherein the fingerprint comprises a representation of a physical aspect of an entity.

5. A system for securing information according to claim 4, wherein the physical aspect of an entity comprises a representation of an intrinsic physical trait of a human.

6. A system for securing information according to claim 5, wherein the intrinsic physical trait of a human comprises any one of a representation of the markings of the inner surface of the last joint of a digit of a human hand, a representation of the measurements of a human hand, a representation of a retina of an eye, a representation of an iris of an eye, a representation of a facial pattern, a representation of a portion of the deoxyribonucleic acid (DNA), or any combination of two or more of any of the preceding.

7. A system for securing information according to claim 3, wherein the fingerprint comprises a digital representation of an aspect of an entity.

8. A system for securing information according to claim 7, wherein the digital representation of an aspect of an entity comprises a digital identity.

9. A system for securing information according to claim 8, wherein the digital identity comprises one or more digital identifiers comprising any one of an omnidirectional identifier, a unidirectional identifier, a resolvable identifier, a non-resolvable identifier, or any combination of two or more of any of the preceding.

10. A system for securing information according to claim 8, wherein the entity comprises one or more components of a telecommunication system.

11. A system for securing information according to claim 8, wherein the telecommunication system comprises any one of a telegraph network, a telephone network, a radio system, a radio network, a television system, a television network, a computer network, a satellite system, a satellite network, or any combination of two or more of any of the preceding.

12. A system for securing information according to claim 3, wherein the fingerprint comprises a digital representation of at least a portion of the electromagnetic spectrum.

13. A system for securing information according to claim 3, wherein the portion of the electromagnetic spectrum comprises any one of a portion of the visible spectrum or optical spectrum, a portion of the audio spectrum, or a portion of the visible or optical spectrum and a portion of the audio spectrum.

14. A system for securing information according to claim 13, wherein the portion of the visible spectrum comprises any one of a still image, a sequence of still images, or a still image and a sequence of still images.

15. A system for securing information according to claim 14, wherein the portion of the sequence of still images comprises at least a portion of a video.

16. A system for securing information according to claim 14, wherein the portion of the sequence of still images comprises an N-minute stream.

17. A system for securing information according to claim 13, wherein the portion of the audio spectrum comprises any one of a portion of the audio spectrum found in nature, a portion of the audio spectrum synthesis by humans, or a portion of the audio spectrum found in nature and a portion of the audio spectrum synthesis by humans.

18. A system for securing information according to claim 17, wherein the portion of the audio spectrum synthesis by humans comprises music.

19. A system for securing information according to claim 17, wherein the portion of the audio spectrum found in nature any one of speech, an animal sound, or speech and an animal sound.

20. A system for securing information according to claim 1, wherein the first security module and the second security module are the same.

21. A system for securing information according to claim 1, wherein the key comprises a master key and a session key.

22. A system for securing information according to claim 21, wherein the master key comprises a first plurality of words and the session key comprises a second plurality of words.

23. A system for securing information according to claim 22, wherein a number of the first plurality and a second number second plurality of words comprise any one of a different number or a same number.

24. A system for securing information according to claim 22, wherein the first plurality and second plurality of words range in size from machine word size to machine processor size.

25. A system for securing information according to claim 24, wherein any one of
(a) a size of each of the first plurality words comprises any one of a different word size, a same word size, or a combination of a different and a same word size;
(b) a size of each of the second plurality words comprises any one of a different word size, a same word size, or a combination of a different and a same word size; or
(c) a size of each of the first plurality words and the second plurality words comprises any one of a different word size, a same word size, or a combination of a different and a same word size.

26. A system for securing information according to claim 24, wherein the first plurality and second plurality of words comprise in size an at least 4 bit word size.

27. A system for securing information according to claim 24, wherein the first plurality and second plurality of words comprise in size an at least 8-bit word size.

28. A security module useable in a system for securing information comprising an sub-key generator, an encryptor/decryptor, or a sub-key generator and encryptor/decryptor, the security module comprising in linkable arrangement:
(a) an expander;
(b) a combiner;
(c) a scrambler; and
(d) a multiple flag hasher.

29. A security module according to claim 28, further comprising in linkable arrangement a randomizer.

30. A security module according to claim 29, wherein the randomizer comprises any one of a pseudo random number generator (PRNG), a linear congruent generator, a nonlinear congruent generator, a linear feedback shift register, an A5 number generator, a Hughes number generator, a Nanoteq number generator, a Rambutan random number generator, an additive random number generator, a Gifford random number generator, an algorithm M random number generator, a PKZIP random number generator, a table of random numbers, or any combination of any two or more of the preceding.

31. A security module according to claim 29, wherein the pseudo random generator (PRNG) comprises a multiple stage pseudo random generator (MSPRNG).

32. A security module according to claim 31, wherein the multiple stage pseudo random generator (MSPRNG) comprises a two stage pseudo random generator (TSPRNG).

33. A security module according to claim 30, wherein the pseudo random number generator (PRNG) comprises a Yarrow type random number generator, an ISAAC type random number generator, an ANSI standard type random number generator, or any combination of any two or more of the preceding.

34. A security module according to claim 28, wherein the combiner comprises any one of a Galois field (or finite field) operator, an XOR (or exclusive o) operator, or a Galois field operator and an XOR (exclusive o) operator.

35. A security module according to claim 34, wherein the Galois field (or finite field) operator comprises any one of a prime order Galois field (or finite field) operator, an order of the power of two Galois field (or finite field) operator, or a prime order Galois field (or finite field) operator and an order of the power of two Galois field (or finite field) operator.

36. A security module according to claim 34, wherein the Galois field comprises from 2 to the processor size limit.

37. A security module according to claim 34, wherein the Galois field comprises a Reed Solomon defined Galois field.

38. A security module according to claim 34, wherein the Galois field (or finite field) operator comprises any one of addition (+), subtraction (−), elementwise multiplication (.*), matrix multiplication (*), elementwise left division (./), elementwise right division (.\) matrix left division (/), matrix right division (\), elementwise exponentiation (.̂), elementwise logarithm (log( )), exponentiation of a square Galois matrix by a scalar integer (̂), or any combination of any two or more of the preceding.

39. A security module according to claim 28, wherein the hasher comprises any one of a one-way hasher, a collision resistant hasher (a collision-free hasher), a trapdoor one-way hasher, or a hasher from a class of universal hasher, or any combination of any of the preceding.

40. A security module according to claim 39, wherein the hasher comprises any one of a Gost type hasher, a HAS type hasher, a HAVAL type hasher, an MD type hasher, an N-Hash type hasher, a PANAMA type hasher, a SHA type hasher, a Snefru type hasher, a Tiger type hasher, a VEST type hasher, a WHIRLPOOL type hasher, or any combination of any of the preceding.

41. A security module according to claim 40, wherein the MD type hasher comprises any one of an MD2 type hasher, an MD4 type hasher, an MD5 type hasher, a RIPEMD type hasher, or any combination of any of the preceding.

42. A security module according to claim 40, wherein the RIPEMD type hasher comprises any one of a RIPEMD-160 type hasher, a RIPEMD-128 type hasher, a RIPEMD-256 type hasher, a RIPEMD-320 type hasher, or any combination of any of the preceding.

43. A security module according to claim 40, wherein the SHA type hasher comprises any one of a SHA-0 type hasher, a SHA-1 type hasher, a SHA-224 type hasher, a SHA-256 type hasher, a SHA-384 type hasher, and a SHA-512 type hasher, or any combination of any of the preceding.

44. A security module according to claim 40, wherein the Tiger type hasher comprises any one of a Tiger-192 type hasher, a Tiger-160 type hasher, a Tiger-128 type hasher, a Tiger2 type hasher, or any combination of any of the preceding.

45. A security module according to claim 40, wherein the VEST type hasher comprises any one of a VEST-4, a VEST-8, a VEST-16, a VEST-32, a AES-128, or any combination of any of the preceding.

46. A security module according to claim 40, wherein the PANAMA type hasher comprises a RadioGatún type hasher.

47. A security module according to claim 28, wherein the scrambler comprises any one of at least one bit-shifter, at least one permutator, or at least one bit-shifter and at least one permutator.

48. A security module according to claim 47, wherein the at least one bit-shifter comprises a at least one circular-bit-shifter.

49. A security module according to claim 47, wherein the at least one permutator comprises at least one block-wise permutator.

50. A security module according to claim 47, wherein the at least one bit-shifter comprises at least one circular-bit-shifter, and at least one permutator comprises at least one block-wise permutator.

51. A security module according to claim 28, wherein the expander comprises any one of a randomizer.

52. A security module according to claim 51, wherein the randomizer comprises any one of a pseudo random number generator (PRNG), a linear congruent generator, a nonlinear congruent generator, a linear feedback shift register, an A5 number generator, a Hughes number generator, a Nanoteq number generator, a Rambutan random number generator, an additive random number generator, a Gifford random number generator, an algorithm M random number generator, a PKZIP random number generator, a table of random numbers, or any combination of any two or more of the preceding.

53. A security module according to claim 51, wherein the pseudo random generator (PRNG) comprises a multiple stage pseudo random generator (MSPRNG).

54. A security module according to claim 53, wherein the multiple stage pseudo random generator (MSPRNG) comprises a two stage pseudo random generator (TSPRNG).

55. A security module according to claim 51, wherein the pseudo random number generator (PRNG) comprises a Yarrow type random number generator, an ISAAC type random number generator, an ANSI standard type random number generator, or any combination of any two or more of the preceding.

56. A method in a computer system for securing information, the method comprising:
(a) providing one or more keys;
(b) generating one or more sub-keys using at least one of the one or more keys; and
(c) converting a plain text to a cipher text using the one more sub-keys in combination with one or more of a combining operation, an expanding operation, a scrambling operation, a randomizing operation, and a hashing operation.

57. The method according to claim 56, further comprising providing at least one finger print matrix.

58. The method according to claim 56, wherein the at least one randomizing operation comprises generating at least one randomized matrix and the at least one combining operation comprises combining the at least one finger print matrix and the randomized matrix to create a security matrix.

59. The method according to claim 58, wherein the at least one combining operation comprises any one of a Galois field (or finite field) operation, an XOR (or exclusive o) operation, or a Galois field operation and a XOR (exclusive o) operation.

60. The method according to claim 56, wherein the at least one scrambling operation comprises any one of at least one bit shift operation on a security matrix, at least one permutator operation a security matrix, or at least one bit shift operation and at least one permutator operation on a security matrix.

61. The method according to claim 60, wherein the at least one bit shift operation comprises performing at least one circular-bit-shift operation on the security matrix.

62. The method according to claim 60, wherein the at least one permutator operation comprises performing at least one block-wise permutation on the security matrix.

63. The method according to claim 56, wherein the one or more sub-keys represent a sequence of operations

64. The method according to claim 56, wherein the sub-keys comprises a sequence of 0s and 1s.

65. The method according to claim 64, wherein each 0 represents a bit-shift and each 1 represents a permutation or vice versa in the at least one scrambling operation.

66. The method according to claim 61, wherein the at least one circular-bit-shift operation comprises a plurality of circular-bit-shift operations.

67. The method according to claim 62, wherein the at least one block-wise permutation comprises a plurality of block-wise permutations.

68. The method according to claim 60, wherein at least one circular-bit-shift operation is performed before at least one block-wise permutation.

69. The method according to claim 60, wherein at least one block-wise permutation is performed before at least one circular-bit-shift operation.

70. The method according to claim 60, wherein the at least one scrambling operation comprises a sequence of operations comprising: performing a first of the at least one bit-shift operation; performing a first of the at least one permutation; performing a second of the at least one bit-shift operation; performing a second of the at least one permutation; performing a third of the at least one permutation; and performing a third of the at least one bit-shift operation.

71. The method according to claim 56, wherein the generating of the one or more sub-keys comprises using at least one of the one or more keys in combination with one or more of a combining operation, an expanding operation, a scrambling operation, a randomizing operation, and a hashing operation.

72. A method in a computer system for securing information, the method comprising:
(a) accessing a master key portion;
(b) accessing a session key portion;
(c) providing at least a portion of the master key portion and at least a portion of the session key portion to a sub-key generator to create a plurality of sub-keys;
(d) accessing a plain text;
(e) providing at least a first preselected portion of the sub-keys and the plain text to an encryptor/decryptor to create an intermediate cipher text;
(f) providing at least another preselected portion of the sub-keys and the intermediate cipher text to an encryptor/decryptor to create a further intermediate cipher text; and
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process.

73. A method in a computer system for securing information, the method comprising:
(a) generating a session key portion;
(b) accessing a master key portion;
(c) providing at least a portion of the master key portion and at least a portion of the session key portion to a sub-key generator to create a plurality of sub-keys;
(d) accessing a plain text;
(e) providing at least a first preselected portion of the sub-keys and the plain text to an encryptor/decryptor to create an intermediate cipher text;
(f) providing at least another preselected portion of the sub-keys and the intermediate cipher text to an encryptor/decryptor to create a further intermediate cipher text; and
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process; and
(h) transmitting the session key portion and the substantially secure cipher text over a communications link.

74. A method in a computer system for authorizing access to secure information, the method comprising:
(a) accessing a master key portion;
(b) accessing a session key portion;
(c) providing at least a portion of the master key portion and at least a portion of the session key portion to a sub-key generator to create a plurality of sub-keys;
(d) accessing a substantially secure cipher text;
(e) providing at least a last preselected portion of the sub-keys and the substantially secure cipher text to an encryptor/decryptor to create a further intermediate cipher text;
(f) providing at least another preselected portion of the sub-keys and the further intermediate cipher text to an encryptor/decryptor to create an intermediate cipher text; and
(g) repeating the previous steps (d), (e) and (f) a sufficient number of times so as to create a plain text, wherein the intermediate cipher text of step (f) of a previous process is accessed in place of the substantially secure cipher text of step (d) to create the intermediate cipher text of step (f) for the current process and different preselected portions of the sub-keys are used for each process.

75. A method in a computer system for authorizing access to secure information, the method comprising:
(a) accessing a master key portion;
(b) receiving a transmission of one or more discrete signals representing a session key portion and a substantially secure cipher text;
(c) providing at least a portion of the master key portion and at least a portion of the session key portion to a sub-key generator to create a plurality of sub-keys;
(d) providing at least a last preselected portion of the sub-keys and the substantially secure cipher text to an encryptor/decryptor to create a further intermediate cipher text;
(e) providing at least another preselected portion of the sub-keys and the further intermediate cipher text to an encryptor/decryptor to create an intermediate cipher text; and
(f) repeating the previous steps (d) and (e) a sufficient number of times so as to create a plain text, wherein the intermediate cipher text of step (e) of a previous process is accessed in place of the substantially secure cipher text of step (d) to create the intermediate cipher text of step (e) for the current process and different preselected portions of the sub-keys are used for each process.

76. A method for authorizing access to secure information, the method comprising:
(a) providing a key and a public key to a sub-key generator to create a plurality of sub-keys;
(b) accessing a substantially secure cipher text;
(c) scrambling the substantially secure cipher text using the first preselected portion of the sub-keys to create a further intermediate cipher text;
(d) combining a first preselected portion of the sub-keys and a preselected portion of the further intermediate cipher text;
(e) expanding the combined preselected portions of the sub-keys and the further intermediate cipher text to create a first intermediate data set;
(f) combining the first intermediate data set and the public key to create a second intermediate data set;
(g) combining a second preselected portion of the sub-keys and the preselected portion of the further intermediate cipher text to create a scrambling parameter;
(h) scrambling the second intermediate data set using the scrambling parameter, a third preselected portion of the sub-keys, and a fourth preselected portion of the sub-keys to create a third intermediate data set;
(i) hashing the third intermediate data set;
(j) combining the hashed third intermediate data set and the further intermediate cipher text to create an intermediate cipher text;
(k) scrambling the intermediate cipher text using the first preselected portion of the sub-keys to create an intermediate cipher text; and
(l) repeating steps (b) through (k) a sufficient number of times so as to create a plain text, wherein the intermediate cipher text of step (k) of a previous process is used in place of the further intermediate cipher text of step (b) for a current process and the first preselected portion of the sub-keys of step (c), the second preselected portion of the sub-keys of step (g), and the third preselected portion and the fourth preselected portions of the sub-keys of step (h) are different preselected portions of the sub-keys for each process.

77. A method for securing information, the method comprising:
(a) providing a key and a public key to a sub-key generator to create a plurality of sub-keys;
(b) accessing a plain text;
(c) combining a first preselected portion of the sub-keys and a preselected portion of the plain text;
(d) expanding the combined preselected portions of the sub-keys and plain text to create a first intermediate data set;
(e) combining the first intermediate data set and the public key to create a second intermediate data set;
(f) combining a second preselected portion of the sub-keys and the preselected portion of the plain text to create a scrambling parameter;
(g) scrambling the second intermediate data set using the scrambling parameter, a third preselected portion of the sub-keys, and a fourth preselected portion of the sub-keys to create a third intermediate data set;
(h) hashing the third intermediate data set;
(i) combining the hashed third intermediate data set and the plain text to create an intermediate cipher text;
(j) scrambling the intermediate cipher text using the first preselected portion of the sub-keys to create a further intermediate cipher text; and
(k) repeating steps (b) through (j) a sufficient number of times so as to create a substantially secure cipher text, wherein the further intermediate cipher text of step (j) of a previous process is used in place of the plain text of step (b) for a current process and the first preselected portion of the sub-keys of step (c), the second preselected portion of the sub-keys of step (f), and the third preselected portion and the fourth preselected portions of the sub-keys of step (g) are different preselected portions of the sub-keys for each process.

78. A computer system for securing information, comprising:
(a) a sub-key generator comprising a security module capable of accepting as inputs at least a portion of a key and a public key to create a sub-key as an output;
(b) an encryptor/decryptor comprising the security module capable of accepting as inputs at least a portion of the sub-key, the public key, and a plain text to create a substantially secure cipher text as an output; and
(c) a transmission component capable of transmitting a session key portion of the key and the substantially secure cipher text.

79. A computer system for authorizing access to secure information, the system comprising:
(a) a transmission component capable of receiving a session key portion of a key and a substantially secure cipher text;
(b) a sub-key generator comprising a security module capable of accepting as inputs at least a portion of the key and a public key to create a sub-key as an output; and
(c) an encryptor/decryptor comprising the security module capable of accepting as inputs at least a portion of the sub-key, the public key, and a substantially secure cipher text to create a plain text as an output.

80. A computer program product comprising:
(a) a computer useable medium and computer readable code embodied on said computer useable medium for causing a securing of information, the computer readable code comprising:
(b) computer readable program code devices configured to cause the computer to effect the accessing of a master key portion;
(c) computer readable program code devices configured to cause the computer to effect the accessing of a session key portion;
(d) computer readable program code devices configured to cause the computer to effect the providing of at least a portion of the master key portion and at least a portion of the session key portion to a sub-key generator to create a plurality of sub-keys;
(e) computer readable program code devices configured to cause the computer to effect the accessing a plain text;
(f) computer readable program code devices configured to cause the computer to effect the providing of at least a first preselected portion of the sub-keys and the plain text to an encryptor/decryptor to create an intermediate cipher text;
(g) computer readable program code devices configured to cause the computer to effect the providing of at least another preselected portion of the sub-keys and the intermediate cipher text to an encryptor/decryptor to create an further intermediate cipher text; and
(h) computer readable program code devices configured to cause the computer to effect the repeating of the previous steps (e), (f) and (g) a sufficient number of times so as to create a substantially secure cipher text, wherein the further intermediate cipher text of step (g) of a previous process is accessed in place of the plain text of step (e) to create the further intermediate cipher text of step (g) for the current process and different preselected portions of the sub-keys are used for each process.

81. A computer program product comprising:
(a) a computer useable medium and computer readable code embodied on said computer useable medium for causing a securing of information, the computer readable code comprising:
(b) computer readable program code devices configured to cause the computer to effect the generating of a session key portion;
(c) computer readable program code devices configured to cause the computer to effect the accessing of a master key portion;
(d) computer readable program code devices configured to cause the computer to effect the providing of at least a portion of the master key portion and at least a portion of the session key portion to a sub-key generator to create a plurality of sub-keys;
(e) computer readable program code devices configured to cause the computer to effect the accessing a plain text;
(f) computer readable program code devices configured to cause the computer to effect the providing of at least a first preselected portion of the sub-keys and the plain text to an encryptor/decryptor to create an intermediate cipher text;
(g) computer readable program code devices configured to cause the computer to effect the providing of at least another preselected portion of the sub-keys and the intermediate cipher text to an encryptor/decryptor to create a further intermediate cipher text;
(h) computer readable program code devices configured to cause the computer to effect the repeating of the previous steps (e), (f) and (g) a sufficient number of times so as to create a substantially secure cipher text, wherein the further intermediate cipher text of step (g) of a previous process is accessed in place of the plain text of step (e) to create the further intermediate cipher text of step (g) for the current process and different preselected portions of the sub-keys are used for each process; and
(i) computer readable program code devices configured to cause the computer to effect the transmitting of the session key portion and the substantially secure cipher text over a communications link.

82. A computer program product comprising:
(a) a computer useable medium and computer readable code embodied on said computer useable medium for causing an access to secure information, the computer readable code comprising:
(b) computer readable program code devices configured to cause the computer to effect the accessing of a master key portion;
(c) computer readable program code devices configured to cause the computer to effect the accessing of a session key portion;
(d) computer readable program code devices configured to cause the computer to effect the providing of at least a portion of the master key portion and at least a portion of the session key portion to a sub-key generator to create a plurality of sub-keys;
(e) computer readable program code devices configured to cause the computer to effect the accessing a substantially secure cipher text;
(f) computer readable program code devices configured to cause the computer to effect the providing of at least a last preselected portion of the sub-keys and the substantially secure cipher text to an encryptor/decryptor to create a further intermediate cipher text;
(g) computer readable program code devices configured to cause the computer to effect the providing of at least another preselected portion of the sub-keys and the further intermediate cipher text to an encryptor/decryptor to create an intermediate cipher text; and
(h) computer readable program code devices configured to cause the computer to effect the repeating the previous steps (e), (f) and (g) a sufficient number of times so as to create a plain text, wherein the intermediate cipher text of step (g) of a previous process is accessed in place of the substantially secure cipher text of step (e) to create the intermediate cipher text of step (g) for the current process and different preselected portions of the sub-keys are used for each process.

83. A computer program product comprising:
(a) a computer useable medium and computer readable code embodied on said computer useable medium for causing an access to secure information by a user, the computer readable code comprising:
(b) computer readable program code devices configured to cause the computer to effect the receiving of a master key portion;
(c) computer readable program code devices configured to cause the computer to effect the receiving of a transmission of one or more discrete signals representing a session key portion and a substantially secure cipher text;
(d) computer readable program code devices configured to cause the computer to effect the providing of at least a portion of the master key portion and at least a portion of the session key portion to a sub-key generator to create a plurality of sub-keys;
(e) computer readable program code devices configured to cause the computer to effect the providing of at least a last preselected portion of the sub-keys and the substantially secure cipher text to an encryptor/decryptor to create a further intermediate cipher text;
(f) computer readable program code devices configured to cause the computer to effect the providing of at least another preselected portion of the sub-keys and the further intermediate cipher text to an encryptor/decryptor to create an intermediate cipher text; and
(g) computer readable program code devices configured to cause the computer to effect the repeating the previous steps (e) and (f) a sufficient number of times so as to create a plain text, wherein the intermediate cipher text of step (f) of a previous process is accessed in place of the substantially secure cipher text of step (e) to create the intermediate cipher text of step (f) for the current process and different preselected portions of the sub-keys are used for each process.

84. A computer data signal embodied in a transmission medium, comprising:
(a) a code segment including instructions for accessing a master key portion;
(b) computer readable program code devices configured to cause the computer to effect the accessing of a session key portion;
(c) a code segment including instructions for providing at least a portion of the master key portion and at least a portion of the session key portion to a sub-key generator to create a plurality of sub-keys;
(d) a code segment including instructions for accessing a plain text;
(e) a code segment including instructions for providing at least a first preselected portion of the sub-keys and the plain text to an encryptor/decryptor to create an intermediate cipher text;
(f) a code segment including instructions for providing at least another preselected portion of the sub-keys and the intermediate cipher text to an encryptor/decryptor to create a further intermediate cipher text; and
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process.

85. A computer data signal embodied in a transmission medium, comprising:
(a) a code segment including instructions for generating a session key portion;
(b) a code segment including instructions for accessing a master key portion;
(c) a code segment including instructions for providing at least a portion of the master key portion and at least a portion of the session key portion to a sub-key generator to create a plurality of sub-keys;
(d) a code segment including instructions for accessing plain text;
(e) a code segment including instructions for providing at least a first preselected portion of the sub-keys and the plain text to an encryptor/decryptor to create an intermediate cipher text;
(f) a code segment including instructions for providing at least another preselected portion of the sub-keys and the intermediate cipher text to an encryptor/decryptor to create a further intermediate cipher text;
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process; and
(h) a code segment including instructions for transmitting the session key portion and the substantially secure cipher text over a communications link.

86. A computer data signal embodied in a transmission medium, comprising:
(a) a code segment including instructions for accessing a master key portion;
(b) a code segment including instructions for accessing a session key portion;
(c) a code segment including instructions for providing at least a portion of the master key portion and at least a portion of the session key portion to a sub-key generator to create a plurality of sub-keys;
(d) a code segment including instructions for accessing a substantially secure cipher text;
(e) a code segment including instructions for providing at least a last preselected portion of the sub-keys and the substantially secure cipher text to an encryptor/decryptor to create a further intermediate cipher text;
(f) a code segment including instructions for providing at least another preselected portion of the sub-keys and the further intermediate cipher text to an encryptor/decryptor to create an intermediate cipher text; and
(g) a code segment including instructions for repeating the previous steps (d), (e) and (f) a sufficient number of times so as to create a plain text, wherein the intermediate cipher text of step (f) of a previous process is accessed in place of the substantially secure cipher text of step (d) to create the intermediate cipher text of step (f) for the current process and different preselected portions of the sub-keys are used for each process.

87. A computer data signal embodied in a transmission medium, comprising:
(a) a code segment including instructions for accessing a master key portion;
(b) a code segment including instructions for receiving a transmission of one or more discrete signals representing a session key portion and a substantially secure cipher text;
(c) a code segment including instructions for providing at least a portion of the master key portion and at least a portion of the session key portion to a sub-key generator to create a plurality of sub-keys;
(d) a code segment including instructions for providing at least a last preselected portion of the sub-keys and the substantially secure cipher text to an encryptor/decryptor to create a further intermediate cipher text;
(e) a code segment including instructions for providing at least another preselected portion of the sub-keys and the further intermediate cipher text to an encryptor/decryptor to create an intermediate cipher text; and
(f) a code segment including instructions for repeating the previous steps (d) and (e) a sufficient number of times so as to create a plain text, wherein the intermediate cipher text of step (e) of a previous process is accessed in place of the substantially secure cipher text of step (d) to create the intermediate cipher text of step (e) for the current process and different preselected portions of the sub-keys are used for each process.

88. A method for securing information in an Internet transaction involving information, comprising:
(a) accessing a master key portion;
(b) accessing a session key portion;
(c) providing at least a portion of the master key portion and at least a portion of the session key portion to a sub-key generator to create a plurality of sub-keys;
(d) accessing a plain text;
(e) providing at least a first preselected portion of the sub-keys and the plain text to an encryptor/decryptor to create an intermediate cipher text;
(f) providing at least another preselected portion of the sub-keys and the intermediate cipher text to an encryptor/decryptor to create a further intermediate cipher text; and
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process.

89. A method for securing information in an Internet transaction involving information, comprising:
(a) generating a session key portion;
(b) accessing a master key portion;
(c) providing at least a portion of the master key portion and at least a portion of the session key portion to a sub-key generator to create a plurality of sub-keys;
(d) accessing plain text;
(e) providing at least a first preselected portion of the sub-keys and the plain text to an encryptor/decryptor to create an intermediate cipher text;
(f) providing at least an other preselected portion of the sub-keys and the intermediate cipher text to an encryptor/decryptor to create a further intermediate cipher text;
(g) repeating the previous steps (d), (e) and (f) a sufficient number of times so as to create a substantially secure cipher text, wherein the further intermediate cipher text of step (f) of a previous process is accessed in place of the plain text of step (d) to create the further intermediate cipher text of step (f) for the current process and different preselected portions of the sub-keys are used for each process; and
(i) transmitting the session key portion and the substantially secure cipher text over a communications link.

90. A method for an Internet transaction involving accessing secure information, comprising:
(a) accessing a master key portion;
(b) accessing a session key portion;
(c) providing at least a portion of the master key portion and at least a portion of the session key portion to a sub-key generator to create a plurality of sub-keys;
(d) accessing a substantially secure cipher text;
(e) providing at least a last preselected portion of the sub-keys and the substantially secure cipher text to an encryptor/decryptor to create a further intermediate cipher text;
(f) providing at least another preselected portion of the sub-keys and the further intermediate cipher text to an encryptor/decryptor to create an intermediate cipher text; and
(g) repeating the previous steps (d), (e) and (f) a sufficient number of times so as to create a plain text, wherein the intermediate cipher text of step (f) of a previous process is accessed in place of the substantially secure cipher text of step (d) to create the intermediate cipher text of step (f) for the current process and different preselected portions of the sub-keys are used for each process.

91. A method for an Internet transaction involving accessing secure information, comprising:
(a) accessing a master key portion;
(b) accessing a session key portion;
(c) providing at least a portion of the master key portion and at least a portion of the session key portion to a sub-key generator to create a plurality of sub-keys;
(d) accessing a substantially secure cipher text;
(e) providing at least a last preselected portion of the sub-keys and the substantially secure cipher text to an encryptor/decryptor to create a further intermediate cipher text;
(f) providing at least another preselected portion of the sub-keys and the further intermediate cipher text to an encryptor/decryptor to create an intermediate cipher text;
(g) repeating the previous steps (d), (e) and (f) a sufficient number of times so as to create a plain text, wherein the intermediate cipher text of step (f) of a previous process is accessed in place of the substantially secure cipher text of step (d) to create the intermediate cipher text of step (f) for the current process and different preselected portions of the sub-keys are used for each process; and
(i) transmitting the session key portion and the substantially secure cipher text over a communications link.
